(19) United States
(12) Patent Application Publication
(10) Pub. No.: US 2024/0124156 A1
(43) Pub. Date: Apr. 18, 2024

(54) DEVICES AND METHODS FOR CANTILEVERED-SUPPORT OF AIRCRAFT CARGO PAYLOADS IN FORWARD AND AFT ENDS OF A CARGO BAY

(71) Applicant: ZSM Holdings LLC, Dover, DE (US)

(72) Inventor: Etan D. Karni, Boulder, CO (US)

(21) Appl. No.: 18/549,105

(22) PCT Filed: Mar. 10, 2022
(86) PCT No.: PCT/US2022/019853

§ 371 Date: Sep. 5, 2023

Related U.S. Application Data
(60) Provisional application No. 63/106,439, filed on Oct. 28, 2020.

(51) Int. Cl. B64F 1/32; B64C 1/14; B64C 1/22

(52) U.S. Cl. CPC B64F 1/322; B64C 1/1415; B64C 1/22

(57) ABSTRACT

A fixture for supporting a payload including first and second carriages, first and second cantilevered supports, and a support beam is disclosed. The first and second carriages each have a longitudinal axis that is parallel with the other. Each cantilevered support is coupled to a respective carriage and extends at an oblique angle with respect to the longitudinal axis of the carriage. The first and second cantilevered supports extend substantially parallel to each other. The support beam extends between the cantilevered supports such that a first end of the support beam is coupled to the first support structure and a second end of the support beam is coupled to the second support structure. The cantilevered supports enable the payload to extend into otherwise unusable cargo bay storage space within the nose or tailcones of an aircraft.

### CROSS-REFERENCE TO RELATED APPLICATIONS

This application claims priority to U.S. Provisional Patent Application Ser. No. 63/159,439, entitled “DEVICES AND METHODS FOR CANTILEVERED-SUPPORT OF AIRCRAFT CARGO PAYLOADS IN FORWARD AND AFT ENDS OF A CARGO BAY,” filed Mar. 10, 2021, the disclosure of which is hereby incorporated entirely herein by reference.

### FIELD

The present disclosure relates to cargo aircraft that are configured to carry some portion of its payload in a cargo bay volume enclosed by a moveable nose door and/or in a tailcone of a cargo aircraft.

### BACKGROUND

Increases in global demand for wind energy has catalyzed the development of larger, better-performing wind turbines, as turbines with larger rotor diameters generally capture more wind energy. As turbines continue to improve, wind farm sites in previously undeveloped or underdeveloped locations become viable both onshore and offshore, including existing sites where older turbines need replacement.

A limiting factor to allow for the revitalization of old sites and development of new sites is transporting the wind turbines, and related equipment, to the sites. Wind turbine blades are difficult to transport long distances due to the terrestrial limitations of existing air vehicles and roadway infrastructures. The very long lengths of wind turbine blades (some are presently over 100 meters long and over 5 meters in diameter) make conventional transportation by train or truck very difficult. The long payloads are unable to navigate both horizontal and vertical curves without fouling. Additionally, the large diameters preclude passing payloads through tunnels or beneath obstructions such as overpasses, utility cables, or lights. Unfortunately, the solution is not as simple as making ground vehicles longer and/or larger as these challenges are fundamentally due to the size of the blades being moved.

Further, whether onshore or offshore, delivery of parts can be slow and severely limited by the accessibility of the site. Wind farm sites are often located in remote or mountainous areas, thus requiring new construction and special equipment. Ultimately, transportation logistics become cost prohibitive, resulting in a literal and figurative roadblock to further advancing the use of wind energy on a global scale.

Aerial transportation is one potential solution to moving large wind turbine blades. This requires a bespoke aerial vehicle design, capable of accommodating objects with the unique shape and mass characteristics of wind turbine blades. Special techniques for handling this unconventional cargo developed concurrently with the vehicle can reduce the overall cost of blade transportation and improve the system's performance by other metrics such as volumetric efficiency of the vehicle. These techniques can position the cargo so as to use otherwise wasted space within the vehicle, and/or react the inertial loads of the cargo to at least one of the fixtures used to transport the cargo or the vehicle in a structurally efficient manner.

Some existing cargo aircraft utilize moveable nose doors to access their cargo bays. Further, the tail region of a cargo aircraft can often be an under-utilized portion of the aircraft for purposes of transporting cargo. While moveable ramps may be used for loading/unloading, the cargo is typically only secured for flight fully within a fixed portion of the fuselage, and typically not at either end of the fuselage, including within volume that can be formed by nose and/or tailcone sections of the aircraft. Current aircraft transportation methods fail to maximally utilize the available internal volume within the nose and/or tailcone regions of the aircraft.

Accordingly, there is a need for both features of a cargo aircraft, and of loading systems used to assist in transporting cargo in cargo aircraft, that extend the overall volume of space within the cargo bay that can be utilized for transporting cargo, including by utilizing more of a volume of a nose and/or tailcone region of the cargo aircraft.

### SUMMARY

Certain aspects of the present disclosure provide cantilevered support fixtures for use in interior cargo bays of cargo aircraft to, for example, support ends of elongated aircraft cargo such that the elongated cargo may occupy otherwise unusable volume in the nose of an aircraft. Examples of the present disclosure relate to extremely large cargo aircraft capable of both carrying extremely long payloads and being able to takeoff and land at runways that are significantly shorter than those required by most, if not all, existing large aircraft. For purposes of the present disclosure, a large or long aircraft is considered an aircraft having a fuselage length from fuselage nose tip to fuselage tail tip that is at least approximately 60 meters long. The American Federal Aviation Administration (FAA) defines a large aircraft as any aircraft of more than 12,500 pounds maximum certificated takeoff weight, which can also be considered a large aircraft in the present context, but the focus of size is generally related to a length of the aircraft herein. One example of such an oversized payload capable of being transported using examples of this present disclosure are large wind turbine blades, which can be over 100 meters in length. Examples of the present disclosure enable a payload of such an extreme length to be transported within the cargo bay of an aircraft having a fuselage only slighter longer than the payload, while that aircraft can also takeoff and land at most existing commercial airports, as well as runways that are even smaller, for instance because they are built at a location for landing such cargo aircraft near a site where the cargo is to be used, such as a landing strip built as part of a wind farm.

In a representative example, a support fixture described herein is configured to react the loads from the forward end of an elongated aircraft cargo to locations further aft within the aircraft where, for example, a support structure exists for receiving the load. The support structure can be a structure used in conjunction with transporting the cargo onto the aircraft, or in some embodiments the support structure can be integrated to be a part of the aircraft itself. Accordingly, examples of the present disclosure include payload-receiving fixtures that enable an elongated payload to be carried in a cargo aircraft with a support system (e.g., a floor or rail system) of a given length that is shorter than the length of the elongated payload, thus allowing an end of the elongated payload to extend into a region of the interior cargo bay that is beyond an end of the support system (e.g., a nose cone volume beyond the end of a cargo rail system). It can also allow for storage into the tailcone region where it otherwise may be difficult to provide support to the floor directly underneath the payload.

A fixture for supporting a payload according to a first aspect of the present disclosure includes a first base, a second base, a first cantilevered support, a second cantilevered support, and a support beam. The first base has a first longitudinal axis extending its length, and the second base has a second longitudinal axis extending its length. The first and second longitudinal axes are substantially parallel to each other. The first cantilevered support is coupled to the first base and extends at an oblique angle with respect to the first longitudinal axis. Likewise, the second cantilevered support is coupled to the second base and extends at an oblique angle with respect to the second longitudinal axis. The first and second cantilevered supports extend substantially parallel to each other.

The support beam extends between the first and second cantilevered supports and is configured to receive a payload. More particularly, a first end of the support beam is coupled to the first cantilevered support and a second end of the support beam is coupled to the second cantilevered support. The first end of the support beam is a first longitudinal distance away from a first vertical axis that extends substantially perpendicular to the first longitudinal axis when measured along a line that is substantially parallel to the first longitudinal axis and extends between the first vertical axis and the first end of the support beam. Similarly, the second end of the support beam is a second longitudinal distance away from a second vertical axis that extends substantially perpendicular to the second longitudinal axis when measured along a line that is substantially parallel to the second longitudinal axis and extends between the second vertical axis and the second end of the support beam.

In some embodiments, the first and second bases can include first and second carriages, respectively, and each of the first and second carriages can comprise a brace and a plurality of wheels associated with the brace. Each of the first and second carriages can further include one or more whiffle trees, which can have at least some wheels of the plurality of wheels associated with them. The one or more whiffle trees can be configured to substantially uniformly distribute vertical forces from a payload to at least some of the wheels that form the whiffle tree(s). At least one of the first and second bases can be configured to have a ballast.

In at least some embodiments, a saddle can be associated with the support beam. The saddle can be configured to engage with a wind turbine blade to support the wind turbine blade. For example, the saddle can be configured to engage with a root of the wind turbine blade. The fixture can further include at least one interface associated with each of the first and second cantilevered supports. The interface(s) can be configured to engage with a wind turbine blade to support the wind turbine blade. The interface(s) can include a plurality of bolt interfaces that can be configured to engage with a root of the wind turbine blade, for example by passing bolts through the interfaces and into the root of the wind turbine blade.

The fixture can further include a plurality of support rods that can extend between the two cantilevered supports. The support rods can include first and second support rods. The first support rod can extend from the first base to at least one of a location on the support beam proximate to the second cantilevered support or a location on the second cantilevered support proximate to the support beam. Likewise, the second support rod can extend from the second base to at least one of a location on the support beam proximate to the first cantilevered support or a location on the first cantilevered support proximate to the support beam.

In some embodiments, the fixture can further include at least one loading stand extending between the first cantilevered support and the first base. The fixture can further include at least one loading stand extending between the second cantilevered support and the second base.

The oblique angle formed by the first and second longitudinal axes and the respective first and second cantilevered supports can be approximately in the range of about 10 degrees to about 80 degrees. The first and second longitudinal distances can be approximately in the range of about 0.10 meters to about 10 meters. Other ranges and values of the oblique angle and the first and second longitudinal distances are also provided for in the present disclosure.

In further exemplary embodiments, the first cantilevered support can include a first terminal end coupled to the first base, a second terminal end coupled to the support beam, and a first support body extending between the first and second terminals ends. Similarly, the second cantilevered support can include a third terminal end coupled to the second base, a fourth terminal end coupled to the support beam, and a second support body extending between the third and fourth terminals ends.

In some embodiments, the first cantilevered support can include a first upper cap, a first lower cap, and a first terminal end support rod that extends between outer terminal ends of the first upper and first lower caps. The first upper and first lower caps can extend from the first terminal end support rod to a common point on the first base such that the first upper cap, the first lower cap, and the first terminal end support rod form a substantially triangular shape. Likewise, the second cantilevered support can include a second upper cap, a second lower cap, and a second terminal end support rod that extends between outer terminal ends of the second upper and second lower caps. The second upper and second lower caps can extend from the second terminal end support rod to a common point on the second base such that the second upper cap, the second lower cap, and the second terminal end support rod form a substantially triangular shape. In some such embodiments, the first cantilevered support can further include truss support rods that can extend alternately between the first upper cap and the first lower cap, and the second cantilevered support can further include truss support rods that can extend alternately between the second upper cap and the second lower cap.

In some embodiments, a system for loading a cargo aircraft can include the various embodiments of a fixture described above or elsewhere in the present disclosure, and at least one rail disposed in an interior cargo bay of a cargo aircraft. The interior cargo bay can include a forward bay portion located in a forward end of the cargo aircraft and an aft bay portion located in an aft end of the cargo aircraft. The forward bay portion can extend forward beyond a forward terminal end of the at least one rail. In such embodiments, the fixture can be configured to support a payload in the forward bay portion that extends beyond the forward terminal end of the at least one rail. In some such embodiments, the interior cargo bay can include a kinked bay portion disposed between the forward bay portion and the aft bay portion. The kinked bay portion can define a location at which the aft end of the cargo aircraft begins to raise relative to a longitudinal-lateral plane of the cargo aircraft such that an aft-most terminal end of the aft bay portion can be disposed above the a forward-most terminal end of the forward bay portion. The at least one rail can extend from the forward bay portion, through the kinked bay portion, and into the aft bay portion.

A cargo aircraft can include the various embodiments of a system described above or elsewhere in the present disclosure and an articulating nose cargo door. The articulating nose cargo door can include a forward end of the forward bay portion and can be configured to move between an open position and a closed position. In the closed position, the articulating nose cargo door can form a closed forward end of the interior cargo bay and in the open position the articulating nose cargo door can be moved to expose a cargo opening into the interior cargo bay. The fixture can be configured to support a payload in the forward bay portion that extends within a volume defined by the nose cargo door when the door is in the closed position.

According to a further aspect of the present disclosure, a fixture for supporting a payload in a cargo aircraft includes a first cantilevered support, a second cantilevered support, and a support beam. The first cantilevered support extends at a first oblique angle with respect to at least one of a base of the fixture or a floor of the cargo aircraft. Accordingly, a first longitudinal axis that extends through an entirety of the first cantilevered support forms the first oblique angle with at least one of a base plane extending through a substantial portion of a top surface of a base of the fixture or a floor plane extending through a substantial portion of a top surface of a floor of the cargo aircraft. The second cantilevered support similarly extends at a second oblique angle with respect to at least one of the base of the fixture or the floor of the cargo aircraft. Accordingly, a second longitudinal axis that extends through an entirety of the second cantilevered support forms the second oblique angle with at least one of the base plane or the floor plane.

The support beam extends between the first and second cantilevered supports and is configured to receive a payload. More particularly, a first end of the support beam is coupled to the first cantilevered support and a second end of the support beam is coupled to the second cantilevered support. The first end of the support beam is a first longitudinal distance away from a first vertical axis that extends substantially perpendicular to the respective base or floor plane when measured along a line that is substantially parallel to the respective base or floor plane and extends between the first vertical axis and the first end of the support beam. Similarly, the second end of the support beam is a second longitudinal distance away from a second vertical axis that extends substantially perpendicular to the respective base or floor plane when measured along a line that is substantially parallel to the respective base or floor plane and extends between the second vertical axis and the second end of the support beam.

In some embodiments, the fixture can further include a base. Each of the first and second cantilevered supports can be coupled to the base, with the first cantilevered support being able to extend at the first oblique angle with respect to the base and the second cantilevered support being able to extend at the second oblique angle with respect to the base. In at least some embodiments, the base can further include a first base and a second base. The first base can have a first longitudinal axis that can extend a length of the first base, and the second base can have a second longitudinal axis that can also extend a length of the second base. The first and second longitudinal axes can be substantially parallel to each other. In some such embodiments, the first and second bases can include first and second carriages, respectively. Each of the first and second carriages can include a brace and a plurality of wheels associated with the brace. Further, each of the first and second carriages can include one or more whiffle trees, which can have at least some wheels of the plurality of wheels associated with them. The one or more whiffle trees can be configured to substantially uniformly distribute vertical forces from a payload to at least some of the wheels that form the whiffle tree(s). In at least some embodiments, the base can be configured to have a ballast.

The fixture can further include a plurality of support rods that can extend between the two cantilevered supports. The support rods can include a first support rod that can extend from the base to at least one of a location on the support beam proximate to the second cantilevered support or a location on the second cantilevered support proximate to the support beam. Similarly, the second support rod can extend from the base to at least one of a location on the support beam proximate to the first cantilevered support or a location on the first cantilevered support proximate to the support beam. The fixture can further include at least one loading stand that can extend between the first cantilevered support and the base. Still further, the fixture can include at least one loading stand that can extend between the second cantilevered support and the base.

In some embodiments, the first cantilevered support can include a first terminal end coupled to the base, a second terminal end coupled to the support beam, and a first support body extending between the first and second terminals ends. Similarly, the second cantilevered support can include a third terminal end coupled to the base, a fourth terminal end coupled to the support beam, and a second support body extending between the third and fourth terminals ends. The first cantilevered support can include a first terminal end that can be configured to be coupled to a first location on a first side surface of a cargo aircraft fuselage, as well as a second terminal end that can be coupled to the support beam. The first cantilevered support can also include a first support body that can extend between the first and second terminal ends. Likewise, the second cantilevered support can include a third terminal end that can be configured to be coupled to a second location on a second side surface of the cargo aircraft fuselage, as well as a fourth terminal end that can be coupled to the support beam. The second cantilevered support can also include a second support body that can extend between the third and fourth terminal ends. The first and second locations on the respective first and second side surfaces of the cargo aircraft fuselage can be substantially opposed to each other.

In some exemplary embodiments, the fixture can further include first and second support rods. The first support rod can extend between the first terminal end of the first cantilevered support and one of a location on the support beam proximate to the second cantilevered support or a location on the second cantilevered support proximate to the support beam. Similarly, the second support rod can extend between the third terminal end of the second cantilevered support and one of a location on the support beam proximate to the first cantilevered support or a location on the first cantilevered support proximate to the support beam. The fixture can further include a saddle associated with the support beam. The saddle can be configured to engage with a wind turbine blade to support the wind turbine blade. The saddle can be configured to engage with a root of the wind turbine blade. In some embodiments the fixture can further include at least one interface associated with each of the first and second cantilevered supports. The interface(s) can be configured to engage with a wind turbine blade to support the wind turbine blade. The at least one interface can include a plurality of bolt interfaces that can be configured to engage with a root of the wind turbine blade, for example by passing bolts therethrough and into the root of the wind turbine blade.

Each of the first oblique angle and the second oblique angle can be approximately in the range of about 10 degrees to about 80 degrees. The first and second longitudinal distances can be approximately in the range of about 0.10 meters to about 10 meters. Other ranges and values of the oblique angle and the first and second longitudinal distances are also provided for in the present disclosure.

In some embodiments, the first cantilevered support can include a first upper cap, a first lower cap, and a first terminal end support rod that can extend between outer terminal ends of the first upper and first lower caps. The first upper and first lower caps can extend from the first terminal end support rod to a common point on the respective base or floor such that the first upper cap, the first lower cap, and the first terminal end support rod can form a substantially triangular shape. Likewise, the second cantilevered support can include a second upper cap, a second lower cap, and a second terminal end support rod that can extend between outer terminal ends of the second upper and second lower caps. The second upper and second lower caps can extend from the second terminal end support rod to a common point on the respective base or floor. As a result, the second upper cap, the second lower cap, and the second terminal end support rod can form a substantially triangular shape. In some embodiments, the first cantilevered support can further include truss support rods that can extend alternately between the first upper cap and the first lower cap, and the second cantilevered support can further include truss support rods that can extend alternately between the second upper cap and the second lower cap.

In some embodiments, a system for loading a cargo aircraft can include the various embodiments of a fixture described above or elsewhere in the present disclosure, and at least one rail disposed in an interior cargo bay of a cargo aircraft. The interior cargo bay can include a forward bay portion located in a forward end of the cargo aircraft and an aft bay portion located in an aft end of the cargo aircraft. The forward bay portion can extend forward beyond a forward terminal end of the at least one rail. In such embodiments, the fixture can be configured to support a payload in the forward bay portion that extends beyond the forward terminal end of the at least one rail. In some such embodiments, the interior cargo bay can include a kinked bay portion disposed between the forward bay portion and the aft bay portion. The kinked bay portion can define a location at which the aft end of the cargo aircraft begins to raise relative to a longitudinal-lateral plane of the cargo aircraft such that an aft-most terminal end of the aft bay portion can be disposed above the a forward-most terminal end of the forward bay portion. The at least one rail can extend from the forward bay portion, through the kinked bay portion, and into the aft bay portion.

A cargo aircraft can include the various embodiments of a system described above or elsewhere in the present disclosure and an articulating nose cargo door. The articulating nose cargo door can include a forward end of the forward bay portion and can be configured to move between an open position and a closed position. In the closed position, the articulating nose cargo door forming a closed forward end of the interior cargo bay and in the open position the articulating nose cargo door is moved to expose a cargo opening into the interior cargo bay. The fixture can be configured to support a payload in the forward bay portion that extends within a volume defined by the nose cargo door when the door is in the closed position. The cargo aircraft can include a fuselage having a first side surface and a second side surface The first and second side surfaces can be substantially opposed to each other, and the fixture(s) described above or elsewhere. The first terminal end of the first cantilevered support being coupled to a first location on the first side surface and the third terminal end of the second cantilevered support being coupled to a second location on the second side surface.

The cargo aircraft can further include an articulating nose cargo door. The articulating nose cargo door can include a forward end of the forward bay portion and can be configured to move between an open position and a closed position. In the closed position, the articulating nose cargo door can form a closed forward end of the interior cargo bay and in the open position the articulating nose cargo door can be moved to expose a cargo opening into the interior cargo bay. The fixture can be configured to support a payload in the forward bay portion that extends within a volume defined by the nose cargo door when the door is in the closed position.

According to a further aspect of the present disclosure, a method of supporting a payload within an aircraft includes disposing a cantilevered payload-receiving fixture in an interior cargo bay of an aircraft. The cantilevered payload-receiving fixture includes a plurality of cantilevered supports. The disposing action makes it such that both a receiving portion of the cantilevered payload-receiving fixture located at terminal ends of the cantilevered supports and a payload supported by the receiving portion are disposed within a nose cone door cargo volume of the aircraft while opposed terminal ends of the cantilevered supports are disposed in the interior cargo bay, outside of the nose cone door cargo volume of the aircraft.

In some embodiments, disposing the cantilevered payload-receiving fixture in an interior cargo bay of an aircraft can further include coupling the cantilevered payload-receiving fixture to at least one rail disposed within the interior cargo bay of the aircraft and advancing the cantilevered payload-receiving fixture along the rail(s). Disposing the cantilevered payload-receiving fixture in an interior cargo bay of an aircraft can further include rolling the cantilevered payload-receiving fixture into the interior cargo bay, such as rolling it along the rail(s). Rolling the payload-receiving fixture can further include positioning at least a portion of the cantilevered payload-receiving fixture on a cantilevered tongue of a fuselage of the aircraft. In some embodiments, disposing the cantilevered payload-receiving fixture in an interior cargo bay of an aircraft can further include coupling the payload to the cantilevered payload-receiving fixture. This can include, but is not limited to, coupling the cantilevered payload-receiving fixture to side surfaces of a fuselage of the aircraft.

In some exemplary embodiments, the method can further include moving an articulating nose cargo door of the aircraft from a closed position to an open position to expose a cargo opening into the interior cargo bay. In the closed position, the articulating nose cargo door can form a closed forward end of the interior cargo bay. The plurality of cantilevered supports can extend at an oblique angle with respect to a floor of the aircraft. The oblique angle can be approximately in the range of about 10 degrees to about 80 degrees. The method can further include applying a ballast to the cantilevered payload-receiving fixture. The payload can include at least one wind turbine blade. A length of the payload can be at least about 57 meters, at least 100 meters, or at least 120 meters.

### BRIEF DESCRIPTION OF DRAWINGS

This disclosure will be more fully understood from the following detailed description taken in conjunction with the accompanying drawings, in which:

FIG. 1A is an isometric view of one exemplary embodiment of an aircraft;

FIG. 1B is a side view of the aircraft of FIG. 1A;

FIG. 2A is an isometric view of the aircraft of FIG. 1A with a nose cone door in an open position to provide access to an interior cargo bay of the aircraft;

FIG. 2B is an isometric view of the aircraft of FIG. 2A with a payload being disposed proximate to the aircraft for loading into the interior cargo bay;

FIG. 2C is an isometric, transparent view of the aircraft of FIG. 1A having a payload disposed therein using a rail system;

FIG. 3 is a schematic side view of an aircraft in the prior art, illustrating a lateral axis of rotation with respect to tail strike;

FIG. 4 is a side view of an alternative exemplary embodiment of an aircraft;

FIG. 5 is a side view of the aircraft of FIG. 4 in a take-off position;

FIG. 6 is the side cross-sectional view of the aircraft of FIG. 6A with an exemplary payload disposed in the interior cargo bay;

FIG. 7 is side view of a typical elongated payload, supported by an exemplary cantilevered payload-receiving fixture and a non-cantilevered payload-receiving fixture;

FIG. 8 is a schematic side view of the elongated payload and the payload-receiving fixtures of FIG. 7;

FIG. 9 is a perspective view of the cantilevered payload-receiving fixture of FIG. 7;

FIG. 10A is a perspective view of part of a carriage of the fixture of FIG. 7, illustrating the part of the carriage with and without a brace disposed between two sets of wheels;

FIG. 10B is an isometric view of one exemplary embodiment of the part of the carriage of FIG. 10A being disposed in an interior cargo bay and in an unattached position;

FIG. 10C is an isometric view of the part of the carriage of FIG. 10B disposed in the interior cargo bay and in a mounted position;

FIG. 10D is an isometric view of one exemplary embodiment of a hardpoint fitting for securing the fixture to the interior cargo bay;

FIG. 11 is a side view of the cantilevered payload-receiving fixture of FIG. 7 supporting the elongated payload into a portion of a cargo bay volume of the aircraft of FIG. 2A defined by the nose cone door;

FIG. 12 is a perspective view of another embodiment of a cantilevered payload-receiving fixture supporting the elongated payload into a portion of a cargo bay volume of the aircraft of FIG. 2A defined by the nose cone door;

FIG. 13 is a side view of the cantilevered payload-receiving fixture of FIG. 12;

FIG. 14 is a perspective view of an embodiment of a cantilevered payload-receiving fixture that is attached to one or more sides of an inner cargo volume of the aircraft of FIG. 2C;

FIG. 15 is a side view of the cantilevered payload-receiving fixture of FIG. 14; and

FIG. 16 is a bottom view of the cantilevered payload-receiving fixture and aircraft configuration of FIG. 14.

### DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure.

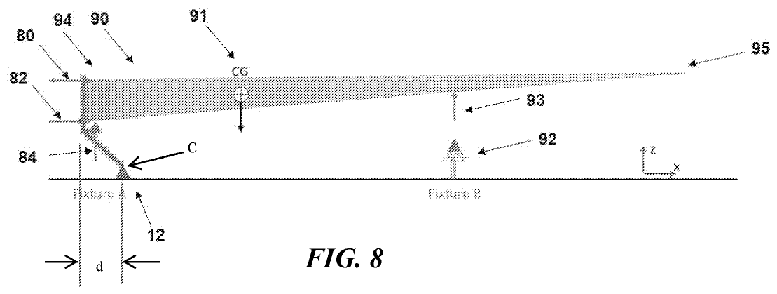

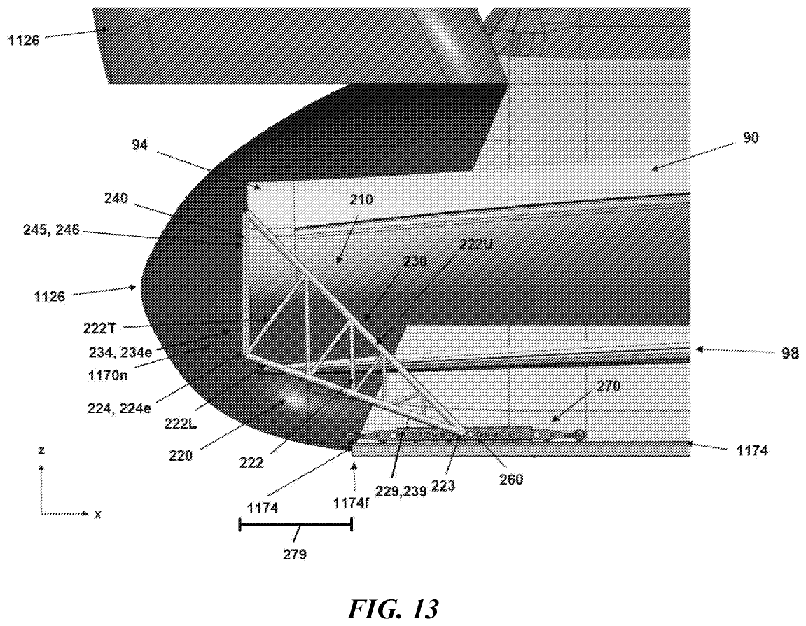

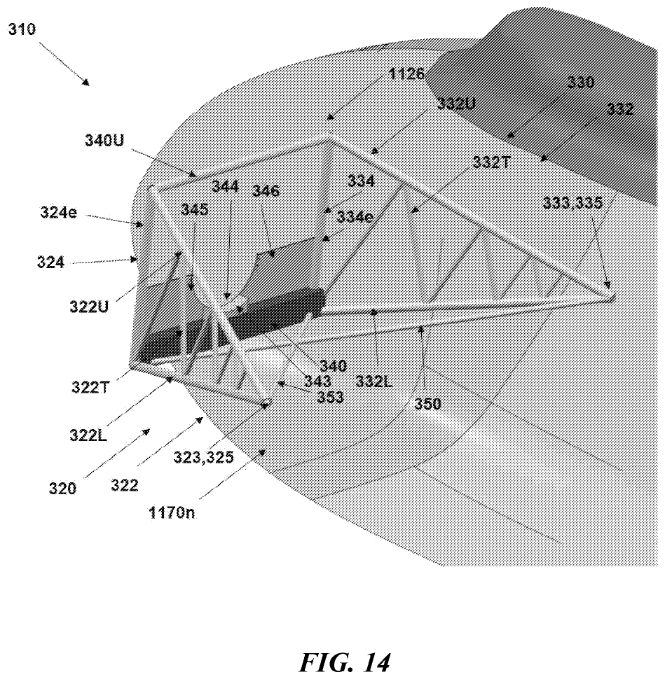

Further, the present disclosure provides some illustrations and descriptions that include prototypes, bench models, and/or schematic illustrations of set-ups, such as FIG. 8 and the embodiment illustrated in FIGS. 13 and 14. A person skilled in the art will recognize how to rely upon the present disclosure to integrate the techniques, systems, devices, and methods provided for herein into a product and/or a system provided to customers, such customers including but not limited to individuals in the public or a company that will utilize the same within manufacturing facilities or the like. To the extent features are described as being disposed on top of, below, next to, etc. such descriptions are typically provided for convenience of description, and a person skilled in the art will recognize that, unless stated or understood otherwise, other locations and positions are possible without departing from the spirit of the present disclosure.

Unless otherwise defined, all technical terms used herein have the same meaning as commonly understood by one of ordinary skill in the art to which this disclosure belongs. Additionally, like-numbered components across embodiments generally have similar features unless otherwise stated or a person skilled in the art would appreciate differences based on the present disclosure and his/her knowledge. Accordingly, aspects and features of every embodiment may not be described with respect to each embodiment, but those aspects and features are applicable to the various embodiments unless statements or understandings are to the contrary. This is also true for like-named devices and components, such as the cantilevered payload-receiving fixtures 12, 210, and 310 provided for herein. That is, although the fixture 12 is not like-numbered with the fixtures 210 and 310, the features and components thereof can carryover between the different embodiments unless otherwise stated or a person skilled in the art would appreciate differences based on the present disclosure and his/her knowledge.

According to the present disclosure, a cantilevered payload-receiving fixture is provided for use at one or both of a forward end or an aft end of an interior cargo bay of an aircraft 100. The cantilevered payload-receiving fixture(s), in conjunction with other payload-receiving fixtures that are not necessarily cantilevered, can be used to support an elongated payload such as one or more wind turbine blades, in the interior cargo bay. More specifically, the cantilevered payload-receiving fixture is configured such that it extends angularly outwards from its base to hold an end portion or terminal portion of the payload (e.g., at or near a root or tip of a wind turbine blade) that is not disposed directly above the base of the fixture. Such a fixture allows the payload to extend into a region of the interior cargo bay that would otherwise be difficult to have a payload stored in (e.g., the nose or tail of an aircraft) at least because without a specially configured fixture like the ones provided for herein it would be difficult to provide the requisite support for the payload in those regions of the interior cargo bay. The payload-receiving fixtures disclosed herein receive loads produced by the wind turbine blade 90 during operation of the aircraft 100 and are configured in a manner such that mechanical stress, strain, tension, and/or other undesirable effects on the payload during aircraft operation may be minimized or eliminated.

### Aircraft

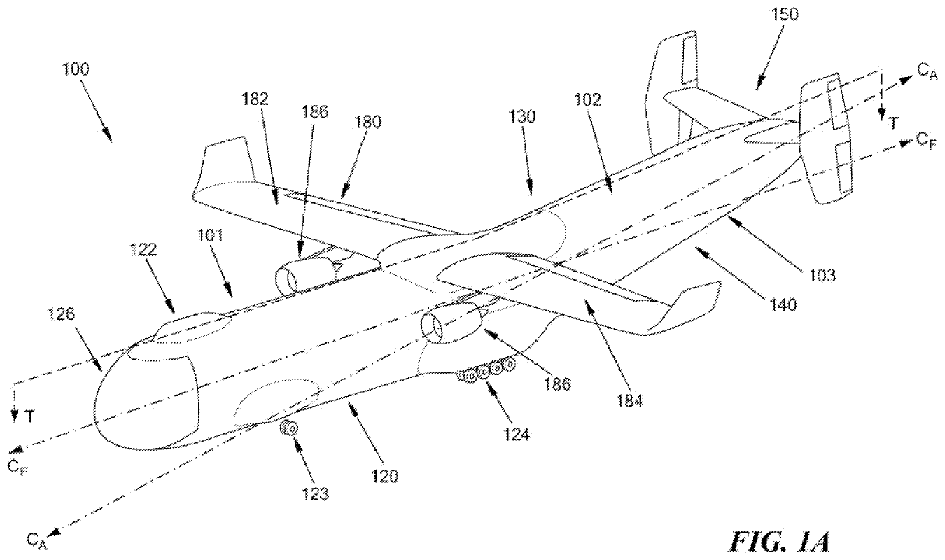

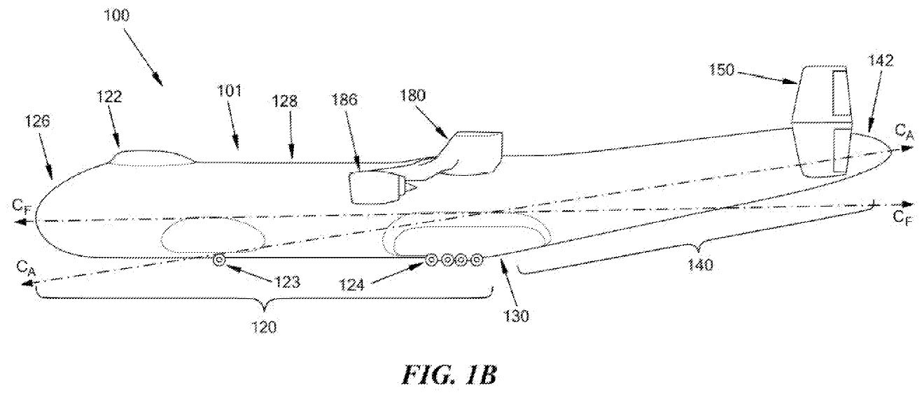

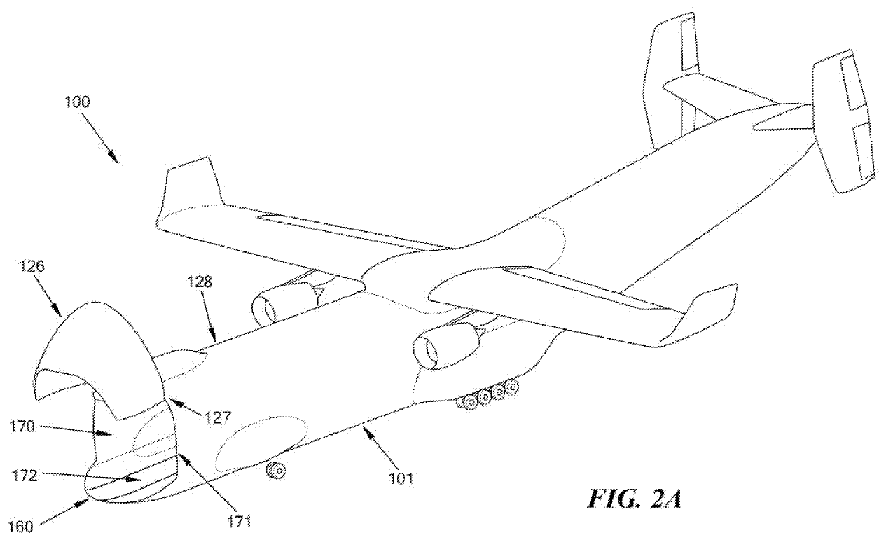

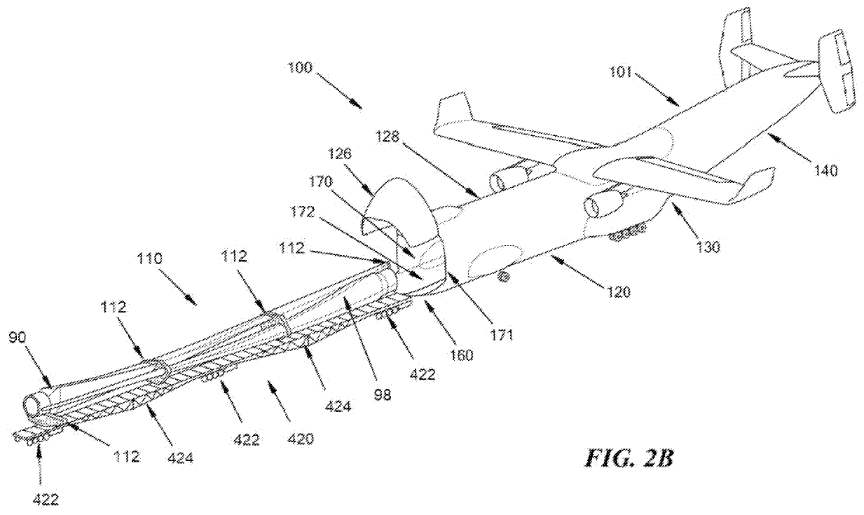

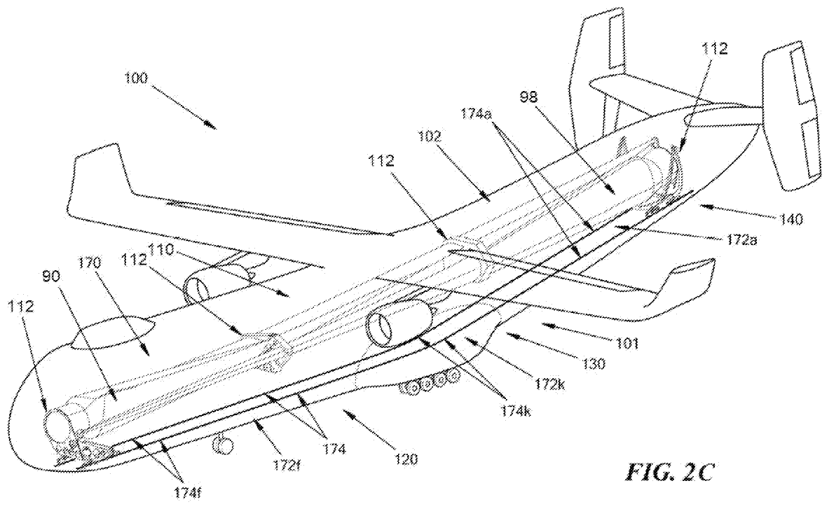

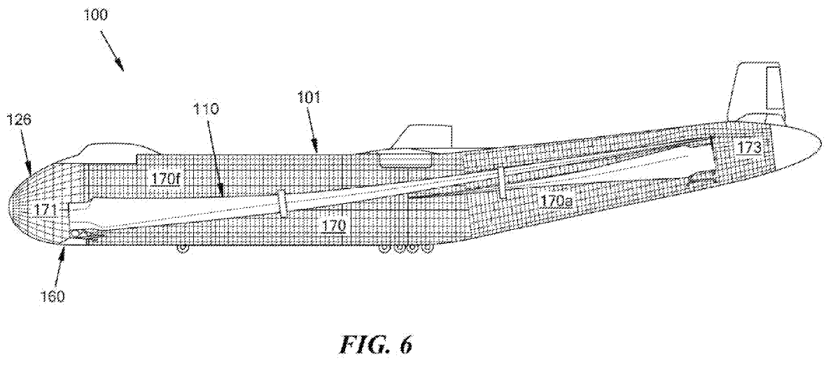

The focus of the present disclosures is described with respect to a large aircraft 100, such as an airplane, illustrated in FIGS. 1A and 1B, along with the loading of a large payload into the aircraft, illustrated at least in FIGS. 2A-2C and 6. In the illustrated embodiment, a payload 110 is a combination of two wind turbine blades 90, 98 (FIGS. 2B and 2C), although a person skilled in the art will appreciate that other payloads are possible. Such payloads can include other numbers of wind turbine blades (e.g., one, two, three, four, etc., or segments of a single even larger blade), other components of wind turbines (e.g., tower segments, generator, hub, etc.), or other large structures and objects whether related to wind turbines or not. The present application can be used in conjunction with most any large payload—large for the present purposes being at least about 57 meters long, or at least about 60, 65, 75, 85, 90, 100, 110, or 120 meters long—or for smaller payloads if desired. Beyond wind turbines, the aircraft 100 can be used with most any size and shape payload, but has particular utility when it comes to large, often heavy and/or bulky and/or irregularly-shaped, payloads.

As shown, for example in FIGS. 1A, 1B, and 2A-2C, the aircraft 100, and thus its fuselage 101, includes a forward end 120 and an aft end 140, with a kinked portion 130 connecting the forward end 120 to the aft end 140. The forward end 120 is generally considered any portion of the aircraft 100, and related components, that are forward of the kinked portion 130 and the aft end 140 is considered any portion of the aircraft 100, and related components, that are aft of the kinked portion 130. The kinked portion 130 is a section of the aircraft 130 in which both a top-most outer surface 102 and a bottom-most outer surface 103 of the fuselage 101 become angled, as illustrated by an aft centerline CA of the aft end 140 of the fuselage 101 with respect to a forward centerline CF of the forward end 120 of the fuselage 101.

The forward end 120 can include a cockpit or flight deck 122, as shown located at a top portion of the aircraft, thus providing more space for cargo, and landing gears, as shown a forward or nose landing gear 123 and a rear or main landing gear 124. The forward-most end of the forward end 120 includes a nose cone 126. As illustrated more clearly in FIG. 2A, the nose cone 126 can be functional as a door, optionally referred to as the nose cone door 126, opening about a hinge 127, thus allowing access to an interior cargo bay 170 defined by the fuselage 101 via a cargo opening 171 exposed by moving the nose cone door 126 into an open or loading position as shown.

The interior cargo bay 170 is continuous throughout the length of the aircraft 101, i.e., it spans a majority of the length of the fuselage. The continuous length of the interior cargo bay 170 includes the space defined by the fuselage 101 in the forward end 120 defining a forward bay portion of the cargo bay 170, the aft end 140 defining an aft bay portion of the cargo bay 170, and the kinked portion 130 defining a kinked bay portion of the cargo bay 170 disposed therebetween. The interior cargo bay 170 can thus include the volume defined by nose cone 126 when closed, as well as the volume defined proximate to a fuselage tailcone 142 located at the aft end 140. The fixed portion 128 of the forwards fuselage 101 is the portion that is not the nose cone 126, and thus the forwards fuselage 101 is a combination of the fixed portion 128 and the nose cone 126. Alternatively, or additionally, the interior cargo bay 170 can be accessed through other means of access, including but not limited to a door located in the aft end 140.

One advantage provided by the illustrated configuration is that by not including an aft door, the interior cargo bay 170 can be continuous, making it significantly easier to stow cargo in the aft end 140 all the way into the fuselage tailcone 142. Existing large cargo aircraft are typically unable to add cargo in this way (e.g., upwards and aftwards) because any kink present in their aft fuselage is specifically to create more vertical space for an aft door to allow large cargo into the forwards portion of the aircraft.

A floor 172 can be located in the interior cargo bay 170, and can also extend in a continuous manner, much like the bay 170 itself, from the forward end 120, through the kinked portion 130, and into the aft end 140. The floor 172 can thus be configured to have a forward end 172f, a kinked portion 172k, and an aft end 172a. In some embodiments, the floor 172 can be configured in a manner akin to most floors of cargo bays known in the art. In some other embodiments, one or more rails can be disposed in the interior cargo bay 170 and can be used to assist in loading a payload, such as the payload 110, into the interior cargo bay 170 and/or used to help secure the location of a payload once it is desirably positioned within the interior cargo bay 170. In order for a cargo aircraft 100 to have as large of a cargo bay 170 as possible, the bottom contact surface 172 can be, effectively, the inner-facing side of the exterior skin of the fuselage. In such an arrangement, the bottom contact surface 172 is not designed to carry significant of the weight of the payload. Instead, rails can be structurally integrated with the fuselage 101 to carry the weight of the payload. A traditional cargo bay floor can be provided using a plurality of cargo bay floor segments that removably attach to the rails and can be advanced into the cargo bay 170 to form a continuous flat cargo bay floor.

Opening the nose cone 126 not only exposes the cargo opening 171 and the floor 172, but it also provides access from an outside environment to a cantilevered tongue 160 that extends from or otherwise defines a forward-most portion of the fixed portion 128 of the fuselage 101. The cantilevered tongue 160 can be used to support a payload, thus allowing the payload to extend into the volume of the interior cargo bay 170 defined by the nose cone 126. Additional details about the cantilevered tongue 160, and relates aspects, can be found in International Patent Application No. PCT/US2020/049785, entitled “VOLUMETRICALLY EFFICIENT CARGO AIRCRAFT,” and filed Sep. 8, 2020, and the content of which is incorporated by reference herein in its entirety.

A wingspan 180 can extend substantially laterally in both directions from the fuselage. The wingspan 180 includes both a first and second fixed wings 182, extending substantially perpendicular to the fuselage 101. In the illustrated embodiment, two engines 186, one mounted to each wing 182, 184, are provided, and other locations for engines are possible, such as being mounted to the fuselage 101. More than two engines, such as three, four, or six, may also be used.

The kinked portion 130 provides for an upward transition between the forward end 120 and the aft end 140. The kinked portion 130 includes a kink, i.e., a bend, in the fixed portion 128 of the fuselage 101 such that both the top-most outer surface 102 and the bottom-most outer surface 103 of the fuselage 101 become angled with respect to the centerline CF of the forward end 120 of the aircraft 100. Notably, although the present disclosure generally describes the portions associated with the aft end 140 as being “aft,” in some instances they may be referred to as part of a “kinked portion” or the like because the entirety of the aft end 140 is angled as a result of the kinked portion 130. Despite the angled nature of the aft end 140, the aircraft 100 is specifically designed in a manner that allows for the volume defined by the aft end 140, up to almost the very aft-most tip of the aft end 140, i.e., the fuselage tailcone 142, to receive cargo as part of the continuous interior cargo bay 170.

Proximate to the fuselage tailcone 142 can be an empennage 150, which can include horizontal stabilizers for providing longitudinal stability, elevators for controlling pitch, vertical stabilizers for providing lateral-directional stability, and rudders for controlling yaw, among other empennage components known to those skilled in the art.

The aircraft 100 is particularly well-suited for large payloads because of a variety of features, including its size. A length from the forward-most tip of the nose cone 126 to the aft-most tip of the fuselage tailcone 142 can be approximately in the range of about 60 meters to about 150 meters. Some non-limiting lengths of the aircraft 100 can include about 80 meters, about 84 meters, about 90 meters, about 95 meters, about 100 meters, about 105 meters, about 107 meters, about 110 meters, about 115 meters, or about 120 meters. Shorter and longer lengths are possible. A volume of the interior cargo bay 170, inclusive of the volume defined by the nose cone 126 and the volume defined in the fuselage tailcone 142, both of which can be used to stow cargo, can be approximately in the range of about 1200 cubic meters to about 12,000 cubic meters, the volume being dependent at least on the length of the aircraft 100 and an approximate diameter of the fuselage (which can change across the length). One non-limiting volume of the interior cargo bay 170 can be about 6850 cubic meters. Not accounting for the very terminal ends of the interior cargo bay 170 where diameters get smaller at the terminal ends of the fuselage 101, diameters across the length of the fuselage, as measured from an interior thereof (thus defining the volume of the cargo bay) can be approximately in the range of about 4.3 meters to about 13 meters, or approximately in the range of about 8 meters to about 11 meters. One non-limiting diameter of the fuselage 101 proximate to its midpoint can be about 9 meters. One non-limiting length of the wingspan 180 can be about 80 meters.

A person skilled in the art will recognize these sizes and dimensions are based on a variety of factors, and thus they are by no means limiting. Nevertheless, the large sizes that the present disclosure both provides the benefit of being able to transport large payloads, but faces challenges due, at least in part, to its size that make creating such a large aircraft challenging. The engineering involved is not merely making a plane larger. As a result, many innovations tied to the aircraft 100 provided for herein, and in other commonly-owned patent applications, are the result of very specific design solutions arrived at by way of engineering.

### Payload Loading, Unloading, and Stowing

FIGS. 2B and 2C provide for a general, simplified illustration of one exemplary embodiment of loading a large payload 110 into the aircraft 100. As shown, the cargo nose door 126 is open, exposing the interior cargo bay 170, which can extend through the kinked portion 130 and through essentially the entirety of the aft end 140. The cargo opening 171 provides access to the interior cargo bay 170, and the cantilevered tongue 160 can be used to help initially receive the payload. As shown, the payload 110 includes two wind turbine blades 90, 98, held with respect to each other by payload-receiving fixtures 112. The payload-receiving fixtures 112 are generally considered part of the payload, although in an alternative interpretation, the payload 110 can just be configured to be the blades 90, 98.

The payload 110, which can also be referred to as a package, particularly when multiple objects (e.g., more than one blade, a blade(s) and ballast(s)) are involved, possibly secured together and manipulated as a single unit, can be delivered to the aircraft 100 using most any suitable devices, systems, vehicles, or methods for transporting a large payload on the ground. A package can involve a single object though. In the illustrated embodiment, a transport vehicle 420 includes a plurality of wheeled mobile transporters 422 linked together by a plurality of spans, as shown trusses 424. Alternatively, or additionally, an outside mechanism can be used to move the vehicle 420, such as a large vehicle to push or pull the vehicle 20, or various mechanical systems that can be used to move large payloads, such as various combinations of winches, pulleys, cables, cranes, and/or power drive units.

As shown in FIG. 2B, the transport vehicle 420 can be driven or otherwise moved to the forward end 120 of the aircraft 100, proximate to the cargo opening 171. Subsequently, the payload 110 can begin to be moved from the transport vehicle 420 and into the interior cargo bay 170. This can likewise be done using various combinations of one or more winches, pulleys, cables, cranes, and/or power drive units, such set-ups and configurations being known to those skilled in the art. The system and/or methods used to move the payload 110 into the cargo bay 170 can continue to be employed to move the payload 110 into the fully loaded position illustrated in FIG. 2C. FIG. 2C is a perspective view of the cargo aircraft 100 of FIG. 1A showing a pair of rails 174 coupled to, extending from, or otherwise associated with the bottom contact surface 172 of the cargo bay 170 that extends along the cargo bay 170 from a forward entrance to and through the aft section of the cargo bay 170 in the aft portion 140 (not visible) of the fuselage 101. The rails 174 can thus be configured to have a forward end 174f, a kinked portion 174k, and an aft end 174a. In some embodiments, the rail(s) 174 can serve as a primary structural member(s) or beam(s) of the fuselage 101, capable of bearing operational flight and/or ground loads, akin to a keel beam in some aircraft.

Additional details about tooling for cargo management, including rails and payload-receiving fixtures and fuselage configuration for enabling loading and unloading of payloads into aft regions of a continuous interior cargo bay are provided in International Patent Application No. PCT/US2020/049784, entitled “SYSTEMS AND METHODS FOR LOADING AND UNLOADING A CARGO AIRCRAFT,” and filed Sep. 8, 2020, and the content of which is incorporated by reference herein in its entirety. Additional details about the use of vehicles and fixtures to load and unload a cargo aircraft are provided in International Patent Application No. PCT/US2020/049782, entitled “SYSTEMS, METHODS, AND VEHICLES FOR TRANSPORTING CARGO ONTO AND OFF A TRANSPORT VEHICLE,” and filed on Sep. 8, 2020, and the content of which is incorporated by reference herein in its entirety. Still further, additional details about assembling and loading large cargo onto a cargo aircraft are provided in International Patent Application No. PCT/US2021/021795, entitled “SYSTEMS AND METHODS FOR ASSEMBLING LARGE CARGO AND LOADING IT ONTO A CARGO AIRCRAFT,” and filed on Mar. 10, 2021, and the content of which is incorporated by reference herein in its entirety.

As a result of the unique nature of the kinked cargo bay configuration, new challenges arise when trying to load or unload large cargo into or out of the non-linear cargo bay. One solution involves systems and methods for loading and unloading the cargo along a curved path inside the fuselage. Examples include tooling and fixtures to enable moving a large cargo in a forward or aft direction while concurrently rotating the large cargo about a center point of an arc such that the large cargo moves along a curved or arc path in a forward or aft direction within the aircraft. Additional details are provided in International Patent Application No. PCT/US2021/21794, entitled “SYSTEMS AND METHODS FOR LOADING AND UNLOADING A CARGO AIRCRAFT UTILIZING A CURVED PATH,” and filed Mar. 10, 2021, and the content of which is incorporated by reference herein in its entirety.

### Kinked Fuselage

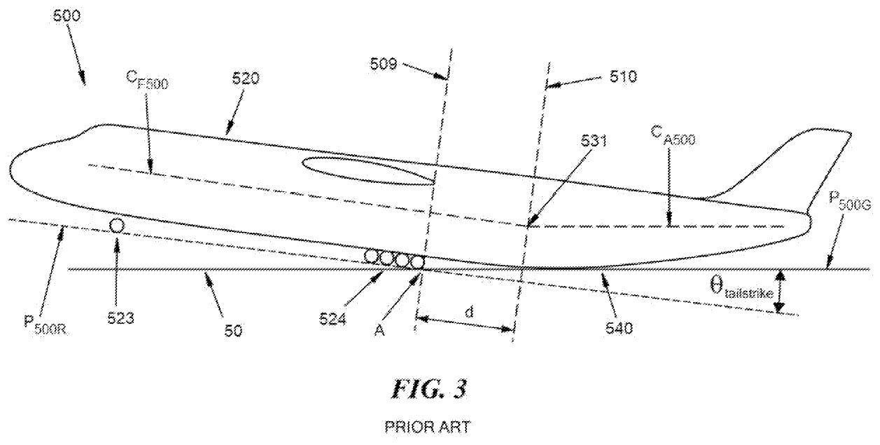

FIG. 3 is an illustration of a prior art aircraft 500 during a takeoff pitch-up maneuver showing the calculating of a tailstrike angle (θₜₐᵢₗₛₜᵣᵢₖₑ), which is determined when a forward end 520 of the aircraft 500 is lifted away from the ground P 500G (e.g., a runway of an airport) and an aft end 540 and tail of the aircraft 500 is pushed towards the ground 50 until contact. This change occurs during a takeoff pitch-up maneuver when the aircraft 500 pitches (e.g., rotates) about a lateral axis of rotation, indicated as “A” in FIG. 3. This lateral axis of rotation, A, is typically defined by the main landing gear 524, which acts as a pivot point to allow a downwards force generated by the tail to lift the forward end 520 of the aircraft 500. In FIG. 3, the nose landing gear 523 and main landing gear 524 define a resting plane P_{500R} (e.g., plane horizontal with the ground plane P_{500G} when the aircraft is resting), such that the tailstrike angle θₜₐᵢₗₛₜᵣᵢₖₑ can be defined by the change in the angle of the ground plane P 300G with respect to the resting plane P 500R when the aircraft 500 has achieved a maximal pitch angle or takeoff angle, which occurs just before any part of the aft end 540 of the aircraft 500 strikes the ground. In FIG. 3, a forward center line C_{F500} of the aircraft 500 is shown, along with an aft centerline C_{A500}. In order to increase θₜₐᵢₗₛₜᵣᵢₖₑ, larger aircraft 500 usually have an upsweep to the lower surface of an aft region of the aft fuselage. This upsweep deflects the centerline C_{A500} with respect to the forward center line C_{F500} at the initiation of the upsweep, which is shown in FIG. 3 as a bend 531 in the centerlines C_{F500}, C_{A500}. In prior art aircraft 500, this bend 531 occurs a certain distance, shown in FIG. 3 as distance “d” aft of the lateral axis of rotation A. Longer values of distance “d” increase the constant cross-section length of the aircraft 500. Aspects of the present disclosure eschew this prior art incentive for increasing distance “d” and instead significantly reconfigure the relationship between the aft fuselage and forward fuselage such that decreasing distance “d” can result in increasing the maximum usable cargo bay length.

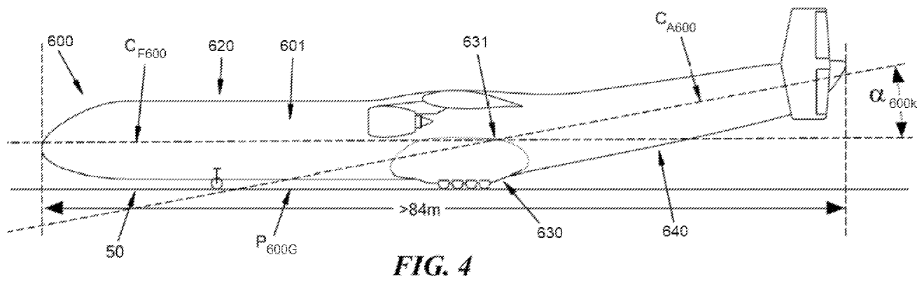

FIG. 4 is a side view illustration of an exemplary cargo aircraft 600 of the present disclosure. The aircraft 600, which is shown to be over 84 meters long, includes a fuselage 601 having a forward end 620 defining a forward centerline C_{F600} and an aft end 640 defining an aft centerline C_{A600}, with the aft centerline C_{A600} being angled up with respect to the forward centerline C_{F600}. The forward and aft centerlines C_{F600}, C_{A600} define a junction or kink 631 therebetween, where the forward centerline C_{F600} angles upward as the overall aft fuselage, which is in the aft end 640, changes in direction to be angled with respect to the forward fuselage, which is in the forward end 620. This defines a kink angle α_{600K} of the aft fuselage 640. The kink location 631 is contained in the kinked portion 430 disposed between and connecting the forward and aft ends 620, 640.

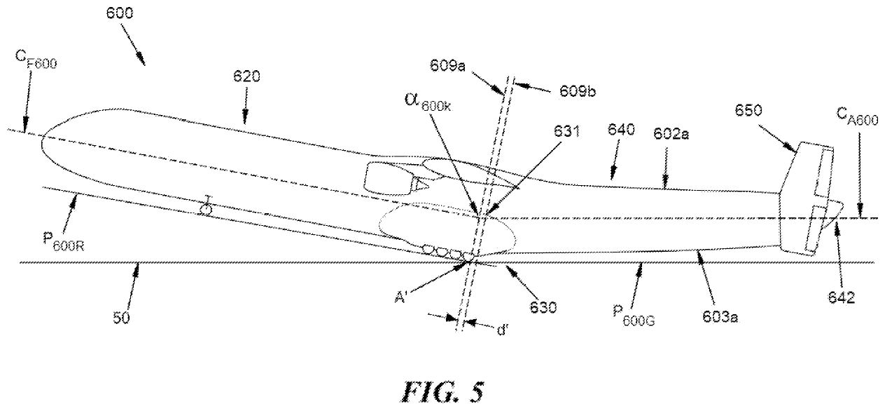

In FIG. 5, the angle of the aft centerline C_{A600} with respect to the forward centerline C_{F600} defines a kink or bend angle (illustrated as α_{600K} in FIG. 4), which can be approximately equal to an average of an angle of the after upper surface 602a and an angle of the lower surface 603a with respect to the forward centerline C_{F600}. Further, the kink angle α600K can be approximately equal to a degree of maximal rotation of the aircraft during the takeoff operation. In FIG. 5, the cargo aircraft 600 is shown on the ground 50 and rotated about the lateral axis of rotation to illustrate, for example, a takeoff pitch-up maneuver. In FIG. 5, a resting plane P_{600R} of the forward end 620 angled with respect to the ground or ground plane P_{600G} at a degree just before θₜₐᵢₗₛₜᵣᵢₖₑ, as no part of the aft end 640, empennage 650, or tail 642 is contacting the ground. In this position, the lower surface 603a (and, approximately, the aft centerline C_{A600}) is substantially parallel with the ground or ground plane P_{600G}, and it can be seen that because the location of the centerline kink 631 of the kinked portion 630 is approximately with, or very close to, the lateral axis of rotation A′, the angle α_{600K} of the kink 631 is approximately the maximum safe angle of rotation of the aircraft 600 about the lateral axis of rotation A′.

FIG. 5 shows a vertical axis 609a aligned with the location of the lateral axis of rotation A′ and another vertical axis 609b aligned with the kink 631 in the fuselage centerline C_{F600}, with a distance d′ therebetween. With d′ being small, and the lower surface 603a of the aft end 640 extending aft with approximately the kink angle α_{600K} of the kink 631 or a slightly larger angle, as shown, the aft end 640 is highly elongated without risking a tail strike. Moreover, the upward sweep of the upper surface 602a can be arranged to maintain a relatively large cross-sectional area along most of the aft end 640, thereby enabling a substantial increase in the overall length of the cargo aircraft 600, and thus usable interior cargo bay within the aft end 640, without increasing θₜₐᵢₗₛₜᵣᵢₖₑ. Vertically aligning the kink location 131 with the lateral pitch axis can enable the aft fuselage 140 to extend without decreasing θₜₐᵢₗₛₜᵣᵢₖₑ, which also can enable the useable portion of the interior cargo bay 170 to extend aft along a substantial portion of the aft fuselage 140. The present designs also enable the creation of extremely long aircraft designs capable of executing takeoff and landing operations with shorter runway lengths than previously possible.

Examples of the aircraft 100 also include complex fuselage changes (e.g., the forward-to-aft kink or bend angle in the fuselage and interior cargo bay centerline) occurring over multiple transverse frames and longitudinally continuous skin panels, thus reducing the overall structural complexity of the transition zone. Additional details about kinked fuselages are provided in International Patent Application No. PCT/US21/21792, entitled “AIRCRAFT FUSELAGE CONFIGURATIONS FOR UPWARD DEFLECTION OF AFT FUSELAGE,” and filed Mar. 10, 2021, and the content of which is incorporated by reference herein in its entirety.

### Cargo Bay

FIG. 6 is side cross-section view of the cargo aircraft 100, the cross-section being taken along an approximate midline T-T of the top-most outer surface, as shown in FIG. 1A. The cargo bay 170 extends from a forward end 171 of a forward end or region 170f of the cargo bay 170, as shown located in the nose cone 126, to an aft end 173 of an aft end or region 170a of the cargo bay 170, as shown located in the fuselage tailcone 142. The forward and aft regions 170f, 170a of the cargo bay 170 sit within the forward and aft ends 120, 140, respectively, of the aircraft 100. FIG. 6 shows the aft region 170a of the cargo bay 170 extending through almost all of the aft fuselage 140, which is a distinct advantage of the configurations discussed herein. FIG. 6 shows a highly elongated payload 110 of two wind turbine blades 90, 98 disposed substantially throughout the interior cargo bay 170 and extending from the forward end 171 of the forward region 170f to the aft end 173 of the aft region 170a.

### Cantilevered Payload-Receiving Fixtures

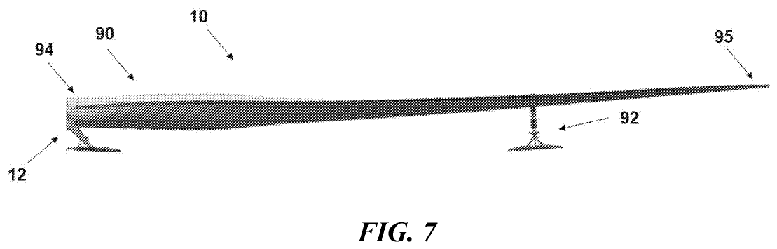

FIG. 7 illustrates an exemplary payload configuration that utilizes a cantilevered payload-receiving fixture 12 and a non-cantilevered payload-receiving fixture 92 to hold a payload 10 that is configured to be secured in an aircraft 1000 substantially similar to aircraft 100 described above. The payload 10 is a wind turbine blade 90, with the cantilevered payload-receiving fixture engaging the blade 90 at an end portion or terminal portion, as shown a root 94, of the blade 90, and the non-cantilevered payload-receiving fixture 92 engaging another portion of the blade 90, forward of an opposed end portion or terminal portion, as shown a tip 95. A person skilled in the art, in view of the present disclosures, will understand any number of fixtures 12, 92 can be used, and such fixtures can be placed and/or engage with any portion of the payload 10. For example, a cantilevered payload-receiving fixture 92 can be used to hold and/or support the opposed end portion or terminal portion, near or at the tip 95 and/or more than two fixtures can be used to support the payload 10.

FIG. 8 depicts a non-limiting schematic illustration of how forces are distributed in view of the placement of the payload-receiving fixtures 12 and 92. In particular, FIG. 8 shows simple-support structural conditions present at the payload-receiving fixtures 12, 92, the payload center of gravity (CG) between them, and load interfaces between the payload-receiving fixtures 12, 92 and the payload 90, the end moment being reacted to as a longitudinal force couple, while the transverse shear is reacted to independently.

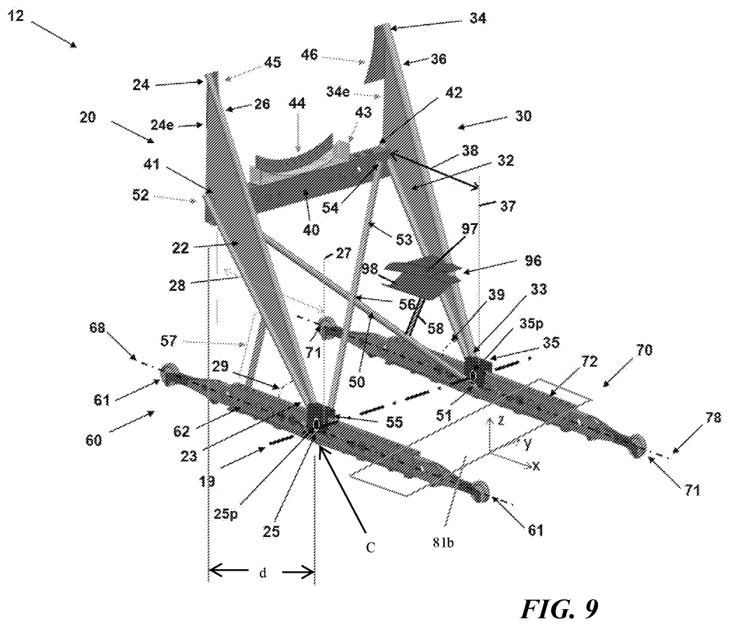

As shown, the non-cantilevered fixture 92 may be arranged near an approximate longitudinal center of the fuselage 101, aft of the CG that provides additional support to the wind turbine blade 90. As shown in FIG. 8, forces acting on the blade 90 include vertical forces 84, 93 supplied by the fixtures 12, 92 counteracting the weight and bending moments of the blade 90. The cantilevered fixture 12, as well as other cantilevered fixtures disclosed herein, is also configured to receive and absorb transverse shear forces 80, 82 that may also act on the blade 90 during aircraft operation. If the non-cantilevered fixture 92 was not present, the vertical gravity load 91 acting at the CG of the elongated cargo would tend to rotate the combined fixture 12, rails (not shown), and wind turbine blade 90 clockwise about the rotational axis 19 shown in FIG. 9. The non-cantilevered fixture 92 provides an additional vertical reaction 93 that stabilizes the payload 10, and the system more generally. A person skilled in the art would understand that the fundamental behavior of the system does not change until the CG of the payload 10 ceases to be positioned at an x-coordinate greater than the x-axis location of the rotational axis 19. If the CG of the payload 10 was positioned at an x-coordinate less than the x-axis location of the rotation axis 19, the vertical reaction 93 at the second fixture 92 can shift from compressive to tensile.

A more detailed illustration of a first embodiment of the cantilevered payload-receiving fixture 12 is provided in FIG. 9. The fixture 12 includes a first cantilevered support 20 and a second, opposed cantilevered support 30, each extending upwardly away from a first carriage 60 and second carriage 70 (also referred to collectively as a base), respectively. A saddle 40 can extend between the supports 20, 30, thereby interconnecting them. The saddle 40 can be configured to support the wind turbine blade 90, for example via interfaces 44, 45, and 46, which are described in further detail below. The interfaces 44, 45, 46 can define a receiving portion of the fixture 12 that is configured to receive the cargo 10, such as the blades 90, 98. A person skilled in the art would understand that the receiving portion can be formed of more or less than the three interfaces 44, 45, 46 described herein.

In the illustrated embodiment, the first cantilevered support 20 includes a support body 22 having a first terminal end 23 and a second terminal end 24 opposite the first terminal end 23. The support body 22 can be formed as a substantially planar, flat structure such as a stiffened aluminum sheet or sandwich panel. In the illustrated embodiment, the support body 22 is imperforate in that it is completely solid and does not include any holes or openings therethrough. In other embodiments, the support body 22 may include one or more holes or openings formed therein, which can make it lighter weight and/or provide features that can be engaged to help translate or otherwise move the fixture 12, such as by way of a winch, pulley, chain, rope, etc. The support body 22 can be made of one or more materials. By way of non-limiting examples, in some embodiments, the support body 22 may be formed of at least one of aluminum, fiberglass, or carbon fiber laminate facesheets bonded to at least one of plastic foam, Nomex or aluminum honeycomb core. A person skilled in the art will appreciate other materials, or combination of materials, that can be used to form the support body 22 without departing from the spirit of the present disclosure. The planar, flat portion of the support body 22 can be arranged relatively vertically. The first terminal end 23 of the support body 22 can be coupled to or otherwise extend from the carriage 60. In other embodiments, the terminal end 23 may be arranged adjacent to the carriage 60 without necessarily being coupled directly to it.

In the illustrated embodiment the first terminal end 23 is coupled to the first carriage 60 utilizing a coupling bracket 25 and pin 25p that secures the support body 22 to the carriage 60, in particular to an upper portion of a rectangular brace 63 of the carriage 60, although a person skilled in the art will understand many different mechanical connections that can be used to secure a location of the support body 22 with respect to the carriage 60, including but not limited to a pinned revolute joint or a flexure joint. In the case of a pinned joint, bushing, roller, and/or ball bearings may be installed on the coupling bracket 25 and/or the carriage 60 to reduce friction and wear. The coupling bracket 25 may include specialized attachment features that correspond to the first terminal end 23 of the support body 22 for insertion and coupling of the support body 22 to the coupling bracket 25. In the illustrated embodiment, the first terminal end 23 may be pivoted about the pin 25p and coupling bracket 25, thus allowing the support 20 to be free to pivot. The first cantilevered support 20 can be prevented from falling forward by a loading stand 57, which will be described in greater detail below. In other embodiments, the first terminal end 23 may be coupled directly to the carriage 60 and/or extend from the carriage 60 by virtue of being of a unitary construction with the carriage 60.

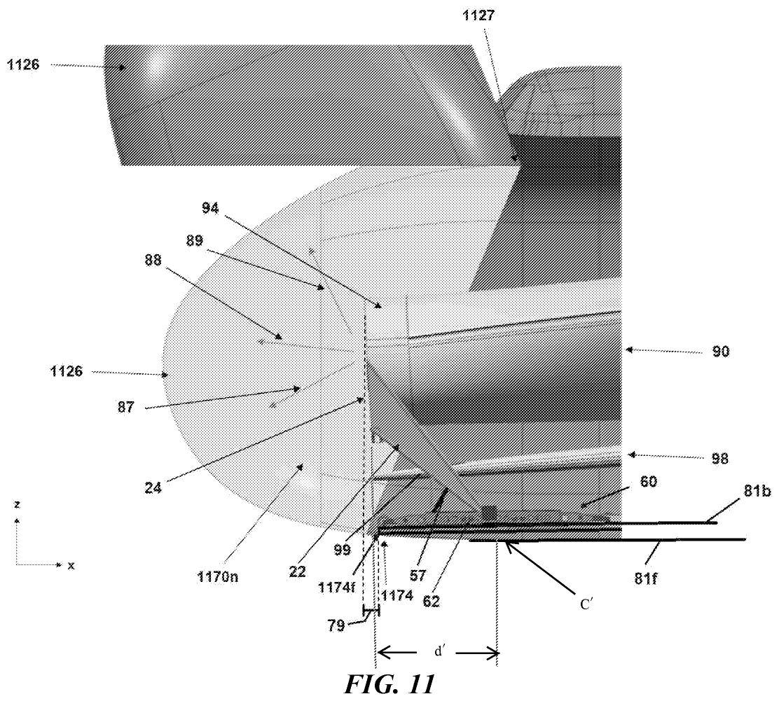

The support body 22 is formed as a substantially triangular shape with the first terminal end 23 having a smaller width than the second terminal end 24, as shown in FIGS. 9 and 11. This shape allows for the second terminal end 24 to be long enough to support the second interface 45 (and similarly the third interface 46 described below) attached thereto. In this way, the top attachment points, in particular the top bolt locations of the interface 45, are able to reach higher points on the circumference of the root 94 of the blade 90, such as near the 0° location of the circumference. This design helps maximize the support provided by the interface 45 and helps maximize the loads received by the interface 45 and the first cantilevered support 20. The design also reduces the weight and associated material costs of the structure. Because the cantilevered support 20 is formed as a cantilevered beam, rigidly connected to the root 94 of the blade 90, the bending moment is maximal at the root 94 and goes to zero at the pin 25p. As such, no moment being present results in there being much less need for width at the first terminal end 23. Other configurations of the support body 22 are possible, including but not limited to a substantially triangular shape with the first terminal end 23 having a larger width than the second terminal end 24 or a rhombus shape in which the first and second terminal ends 23, 24 are equal or nearly equal in width.

In the illustrated embodiment, the first cantilevered support 20 can further include a cap 26 on each longitudinal side (i.e., top and bottom) of the body 22. Each cap 26 can extend along the respective longitudinal side and can also extend outwardly away from the support body 22 in both directions such that a cross-section of the first cantilevered support 20 is formed as an I-shape. The caps 26 provide additional structural support for the first cantilevered support 20 by increasing the second moment of area I_{yy} that resists bending about the rotational axis 19. The laterally elongated form of the caps 26 also stabilize the body 22 against buckling.

The second terminal end 24 can be formed as a substantially straight edge 24e that is generally vertical relative to the carriage 60, as shown in FIGS. 9 and 11. As shown, the second interface 45 can be attached to and/or can extend generally perpendicularly away from the second terminal end 24 of the first cantilevered support 20, with the perpendicular configuration being one in which a plane extending through a substantial entirety of a main planar surface of the second interface 45 is substantially perpendicular to the substantially straight edge 24e. The third interface 46 can similarly be attached to and/or extend generally perpendicularly away from the second terminal end 34 of the second cantilevered support 30. The support beam 40, which will be described in greater detail below, can extend from a lower end of the second terminal end 24, and the second interface 45 can be attached to an upper end of the second terminal end 24. The first cantilevered support 20 terminating as the straight edge 24e at the second terminal end 24 can reduce any excess weight that would exist if the second terminal end 24 were formed as a non-linear edge. Moreover, the straight edge 24e provides an attachment surface for the second interface 45.

The first cantilevered support 20 can extend away from the carriage 60 at a first angle 29 relative to a first longitudinal axis 68 of the first carriage 60. In particular, the angle 29 can be measured between the first longitudinal axis 68, or a base plane 81b of the carriage 60, and a bottom side of the support body 22 of the first cantilevered support 20. The first angle 29 can be an oblique angle. The first angle 29 may also be measured relative to a floor plane 81f that is coplanar with a bottom flat surface of the aircraft 1000, or if the surface is not fully flat, a plane that extends through a substantial portion of a bottom surface (e.g., the equivalent of the floor 172 in the aircraft 100) that a person skilled in the art will appreciate constitutes an equivalent of a bottom surface and a floor plane that extends therethrough for these perspective, descriptive purposes. That is, a person skilled in the art will understand that a plane indicated to be situated with respect to the floor/carriage/base as recited means it passes through essentially the entire surface such that it would be otherwise parallel to that surface if spaced apart from that surface.

The first angle 29 can be, by way of non-limiting examples, approximately in the range of about 10 degrees to about 70 degrees, and more particularly approximately in the range of about 20 degrees to about 65 degrees, and more particularly approximately in the range of about 30 degrees to about 60 degrees, and more particularly approximately in the range of about 35 degrees to about 55 degrees. In the illustrative embodiment, the first angle 29 is approximately 38 degrees, which is found from the preferred locations of the carriage 60 and blade root 94 when loaded aboard the aircraft. The term “approximately” as used in the context of angular measurements refers to +/−3 degrees of the indicated value.

A person skilled in the art, in view of the present disclosures, will understand that the angle 29 impacts a forward-aft offset d from an approximate center C of the payload-receiving fixture 12 that the terminal end 24 can reach, as illustrated in FIGS. 8 and 9. The cantilevered nature of the described configurations allow for a payload to be received and held at the distance d, the distance d being approximately in the range of about 2 meters to about 6 meters from the approximate center of the payload-receiving fixture 12, and in some embodiments the distance d can be about 3.35 meters. A person skilled in the art will appreciate various factors that can impact the distance d that will be suitable for a particular payload, including but not limited to the angle 29, the size, shape, and weight of the payload to be held by the payload-receiving fixture 12, and the strength of the materials and construction used to make the payload-receiving fixture 12. Accordingly, the values for the distance d are not limiting, but represent some useful parameters based on the modeled version disclosed that demonstrate the capabilities of the payload-receiving fixture 12 to support a payload as the payload extends into a region that may otherwise be difficult for the end of the payload to reach (e.g., a region in a nose or tailcone of an aircraft) and be supported for any useful period of time (e.g., during transport, like a flight). A person skilled in the art will appreciate that the cantilevered design of the present disclosure is not limited from a scaling perspective. These same designs can be carried out on smaller scales (e.g., millimeters rather than meters, or less) and significantly larger scales (e.g., 10 times the values described herein, or greater). Accordingly, the values and ranges for the distance d are provided for illustrative purposes and the present disclosure is not necessarily bound by the values and ranges specifically identified herein.

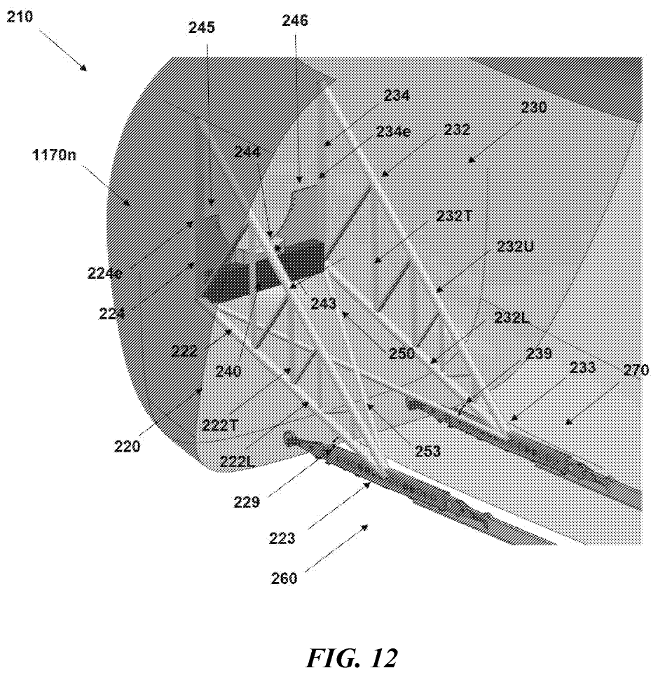

By providing a support 20, the payload-receiving fixture 12 can provide support at a location that is not directly above the location at which the support 20 engages the first carriage 60. In fact, the angled nature of the first cantilevered support 20 can allow for a load to be supported at a location that is not within a vertical plane defined by a length of the carriages 60 and/or 70. This is more clearly illustrated in conjunction with FIG. 12 below.

The second cantilevered support 30 can be similarly configured as the first cantilevered support 20, and such features of a support body 32, a first terminal end 33, a second terminal end 34, a second edge 34e, a coupling bracket 35, a pin 35p, a cap 36, a third interface 46 (having top attachment points that can reach higher points on the circumference of the root 94 of the blade 90, such as near the 180° location of the circumference), and a second angle 39 relative to a second longitudinal axis 78, or base plane 81b, of the second carriage 70 can be similarly provided for as counterpart components associated with the support body 22. Similar to the first angle 29, the angle may also be measured along the floor plane 81f described above and shown in FIG. 11. To the extent some modifications are needed to account for the support body 32 being opposed to the support body 22, and/or the written descriptions of these components requires modification(s) to account for the same, a person skilled in the art will appreciate those modifications. Further, while the illustrated embodiment illustrates support bodies 22, 32 that are substantially similar, a person skilled in the art will appreciate in other embodiments the bodies 22, 32 may have differences. For example, if the payload being supported has a configuration such that having bodies 22, 32 that are differently configured (e.g., shaped, sized, etc.) would be beneficial, such configurations are contemplated by the present disclosures. Thus, for example, while the first angle may be 38 degrees in one embodiment, in that same embodiment the second angle can, but does not necessarily have to be 38 degrees.

In the illustrated embodiment, the first and second cantilevered supports 20, 30 can be substantially parallel with each other, as shown in FIG. 9. In particular, planes defined by substantially planar surfaces of the support bodies 22, 32 can be parallel with each other. In other embodiments, the first and second cantilevered supports 20, 30 may not be exactly parallel, and in other embodiments, the first and second cantilevered supports 20, 30 may be angled relative to each other based, for example, on the structural requirements of the payload-receiving fixture(s) 12, the elongated payload 90, and the aircraft itself. Similarly, the lengths of edges 24e, 34e of each of the first and second cantilevered supports 20, 30 are substantially equal in the illustrative embodiment. However, a person skilled in the art would understand that these lengths may be adjusted based, at least in part, on the structural requirements of the payload-receiving fixture(s) 12, the elongated cargo 90, and the aircraft itself.

The first and second cantilevered supports 20, 30 being angled toward the nose cone door cargo volume 170n allows for the terminal ends 24, 34 of the supports 20, 30 to extend into the otherwise unused nose cone door cargo volume 170n. A person skilled in the art will understand that the angles 29, 39 and length d can be varied to adjust how far into the nose cone door cargo volume 170n the supports 20, 30 extend. Determining how far into the nose cone door cargo volume 170n is acceptable can be determined by a person skilled in the art, in view of the present disclosures, based at least in part on the amount of load (e.g., weight) imparted by the payload 90 on the payload-receiving fixture 12, the strength of the payload-receiving fixture 12, and/or the length of the payload 90. In particular, a distance 79 from the forward edge 174f of the rail 174 to the terminal ends 24, 34, and thus a terminal end of the payload 90 as shown, may be optimized by varying the angles 29, 39 and length d′ in view of the present disclosures. For example, the distance 79 can be approximately in the range of about 0 meters to about 6 meters, and in some embodiments it can be about 4 meters. Although the illustrated embodiment shows the terminal ends 24, 34 to be at a same location as a terminal end of the payload 90, in at least some embodiments a portion of the payload 90 can extend further into the nose cone door cargo volume 170n than the terminal ends 24, 34. Similar to the distance d described above, the ranges and values associated with the distance 79 are for illustrative purposes and the present disclosure is not necessarily bound by the ranges and values. These same designs can be carried out on smaller scales (e.g., millimeters rather than meters, or less) and significantly larger scales (e.g., 10 times the values described herein, or greater).

The lateral support beam 40 can extend between the first and second cantilever supports 20, 30, as shown in FIG. 9. A first end 41 of the support beam 40 can be coupled to the first cantilever support 20 at a lower end of the second terminal end 24, and a second end 42 of the support beam 40 can be coupled to the second cantilever support 30 at a lower end of the second terminal end 34. A top surface of the support beam 40 can form a substantially right angle with the second terminal end 24 as well as the second terminal end 34, although other angles are possible. The support beam 40 can be configured to receive a large portion of the loads produced by the elongated payload 90 and transmit the loads to the cantilevered supports 20, 30. The body of the support beam 40 may include holes formed therein to reduce the weight of the beam. In some embodiments, the support beam 40 can be formed integrally with the first and second cantilever supports 20, 30.

In the illustrated embodiment, the first end 41 of the support beam 40 is coupled to the first cantilevered support 20 at a first distance 28 away from a first vertical axis 27 extending substantially perpendicular to a first longitudinal axis 68 when measured along a line that is substantially parallel to the first longitudinal axis 68 and extends between the first vertical axis 27 and the first end of the support beam 41. Similarly, in the illustrated embodiment, the second end 42 of the support beam 40 is coupled to the first cantilevered support 20 at a second distance 38 away from a second vertical axis 37 extending substantially perpendicular to a second longitudinal axis 78 when measured along a line that is substantially parallel to the second longitudinal axis 78 and extends between the second vertical axis 37 and the second end 42 of the support beam 40. The first and second distances 28, 38 can be approximately in the range of about 0.10 meters to about 10 meters, and more particularly approximately in the range of about 1.5 meters to about 5. meters. In the illustrated embodiment, the distances 28, 38 are approximately 3.2 meters. The term “approximately” as used in the context of distance measurements refers to +/−0.2 meters of the indicated value. Similar to the distance d described above, the ranges and values associated with the distances 28, 38 are for illustrative purposes and the present disclosure is not necessarily bound by the ranges and values. These same designs can be carried out on smaller scales (e.g., millimeters rather than meters, or less) and significantly larger scales (e.g., 10 times the values described herein, or greater).

The payload-receiving fixture 12 can further includes a saddle 43 disposed, coupled to, or otherwise arranged on a top surface of the support beam 40. The saddle 43 can be configured to engage with the root 94 of the wind turbine blade 90 and to support the wind turbine blade 90, for example by way of the first interface 44 that is coupled to, formed as part of, or is otherwise associated with the saddle 43. In the illustrated embodiment the saddle 43 and first interface 44 each include a semi-circular shape that is shaped to substantially match a contour of the root 94 of the wind turbine blade 90. In other embodiments, the saddle 43 and/or first interface 44 may be shaped to match the contour of any elongated payload that is to be secured to the payload-receiving fixture 12. In the illustrated embodiment, the width of the saddle 43 as measured from a forward side to a rearward side is substantially equal to a forward-rearward width of the support beam 40, as shown in FIG. 9, although other widths are possible, including widths greater or less than the support beam 40.

The interfaces 44, 45, 46 can include a plurality of bolt interfaces, as shown bolt holes, configured to engage and support the wind turbine blade 90. Each interface 44, 45, 46 includes a plurality of bolt holes formed therein to engage with the root 94 of the wind turbine blade 90 by passing bolts therethrough and into the root 94 of the wind turbine blade 90. In the illustrated embodiment, the three interfaces 44, 45, 46 are substantially coplanar with each other, although a person skilled in the art would understand that this is not a requirement and may be adjusted based on design requirements. The bolt(s) used in conjunction with each interface 44, 45, 46 can be configured to react to axial loads produced by the wind turbine blade 90. The net bolt pattern of the interfaces 44, 45, 46 can react moments about a y-axis, such as when the cantilevered payload-receiving fixture 12 and the wind turbine blade 90 are rigidly connected and tend to rotate together about the rotational axis 19 shown in FIG. 9.

In the illustrated embodiment, each interface 44, 45, 46 includes a curved outer edge having radii of curvatures that are complementary to the payload being transported. Accordingly, in the illustrated embodiment, together, the curved edges of the three interfaces 44, 45, 46 substantially outline a circular cross-section of the root 94 of the wind turbine blade 90. The bolt holes can be aligned with the curved outer edges of the interfaces 44, 45, 46 such that each bolt hole is located a similar distance away from the curved edge. The first interface 44 may be bolted to a forward side surface of the support beam 40, and the second and third interfaces 45, 46 may be bolted to the second terminal ends 24, 34. In other embodiments, the interfaces 44, 45, 46 are formed integrally with the support beam 40 and the first and second cantilever supports 20, 30. The interfaces 45, 46 may also be located on the outboard sides of the cantilevered supports 20, 30. The interface 44 may also be located below the support beam 40. In some embodiments, the interfaces 44, 45, 46 can be structurally unitary and/or adjacent to each other so as to form a singular, connected or substantially connected shape.

Each of the first, second, and third interfaces 44, 45, 46 can be configured to engage with the wind turbine blade 90, in particular the root 94 of the turbine blade 90, to support the wind turbine blade 90. Three interfaces can provide effective structural support for receiving the loads produced by the wind turbine blade 90. Moreover, the three interfaces can be evenly spaced in the general areas of approximately 45°, approximately 135°, and approximately 225° around a circumference of the root 94 of the blade 90. In this way, the support of the root 94 can be substantially evenly distributed around the lower half of the root 94, thus maximizing load support. In other embodiments, other numbers of interfaces having alternative shapes may be utilized based, at least in part, on the structural requirements of the fixture 12 and elongated cargo 90.

In the illustrated embodiment, the payload-receiving fixture 12 can further include a first support rod 50 and a second support rod 53. The first support rod 50 can include a first terminal end 51 coupled to the coupling bracket 35 and can extend to a second terminal end 52 opposite the first terminal end 51, the second terminal end 52 being coupled to the support beam 40 adjacent the first end 41 of the support beam 40. Similarly, the second support rod 53 can include a first terminal end 54 coupled to the coupling bracket 25 and can extend to a second terminal end 55 opposite the first terminal end 54, the second terminal end 55 being coupled to the support beam 40 adjacent the second end 42 of the support beam 40. In other embodiments, the first terminal ends 51, 54 of the support rods 50, 53 can be coupled directly to the carriages 60, 70, such as rectangular braces 62, 72 of the carriages 60, 70. The support rods 50, 53 can intersect at an intersection point 56. In the illustrated embodiment, the support rods 50, 53 can be adhered to each other at the intersection point 56 to provide additional structural rigidity.

The payload-receiving fixture 12 can further include at least one loading stand, in particular a first loading stand 57, that can extend between the first carriage 60 and the bottom side of the support body 22 of the first cantilevered support 20, as shown in FIG. 9. The first loading stand 57 can be configured to help support the cantilevered supports 20, 30 in the position shown in FIG. 9, as well as prevent the supports 20, 30 from falling forward when a blade 90 is not attached to the fixture 12. The first loading stand 57 can also provide a supporting moment that can counteract bending moment experienced by the payload-receiving fixture 12 and the cargo 90. In the illustrated embodiment, the payload-receiving fixture 12 can further include a second loading stand 58 that can extend between the second carriage 70 and a bottom side of the support body 32 of the second cantilevered support 30 to provide structural support in a similar manner as the first loading stand 57.

The payload-receiving fixture 12 can further include a tip support 96 extending away from the second cantilevered support 30 at approximately one-third of the height of the second cantilevered support 30, as shown in FIG. 9. The tip support 96 can include a top support wall 97 and a bottom support wall 98, each shaped to surround or otherwise secure a tip 99 of a second turbine blade 98 arranged within the aircraft 1000, as shown in FIG. 9 and FIG. 11. The tip support 96 can engage a blade using a variety of techniques, but in the illustrated embodiment the support walls 97 and 98 are flexible and biased such that they can flex outwards to allow a blade tip to pass therebetween and then can flex towards the blade tip based on the walls 97, 98 bias to support the blade tip. A person skilled in the art will appreciate other mechanical solutions that can be used to maintain a position of a blade tip with respect to the payload-receiving fixture 12, including but not limited to compressible foam, rubber liners, and/or an inward acting spring-loaded cam.

While some dimensions, shapes, and configurations of the cantilevered payload-receiving fixture, and components thereof, are illustrated and/or described in the present disclosure, a person skilled in the art will appreciate a number of different dimensions, shapes, and configurations that can be used in place of those described without losing the cantilevered nature of the fixture, and thus without departing from the spirit of the present disclosure. A person skilled in the art will be able to determine and subsequently incorporate such dimensions, shapes, and configurations into cantilevered payload-receiving fixtures as a result. Further, a person skilled in the art will appreciate a variety of different materials that can be used for the various components of the cantilevered payload-receiving fixtures. Some exemplary materials that can be used for making cantilevered payload-receiving fixture structures include: metals such as aluminum, titanium, steel, and/or magnesium alloys; carbon and/or fiberglass reinforced plastic composite laminates, either alone or as facesheets of sandwich panel structures using one or more of plastic foam, balsa wood, aluminum, and/or Nomex honeycomb cores; and/or wood such as spruce and/or bamboo. Plastic foams and/or natural and/or synthetic rubber may also be used in areas contacting the blades, among other materials that would not unnecessarily damage the blades due to being in contact with the blades.

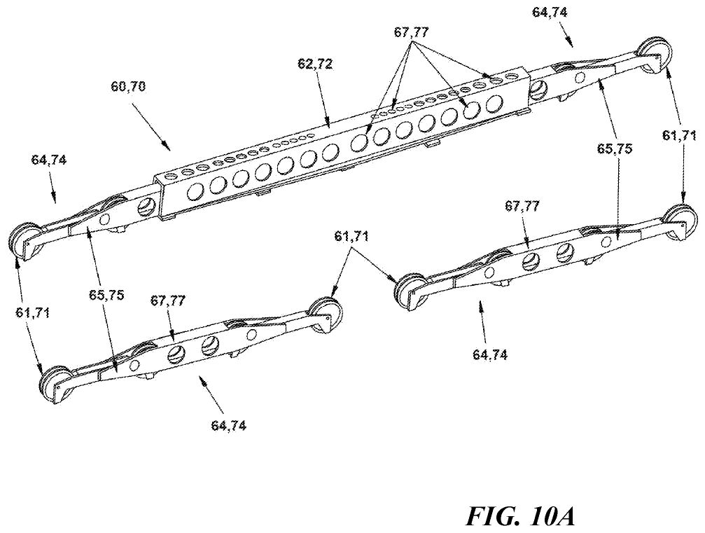

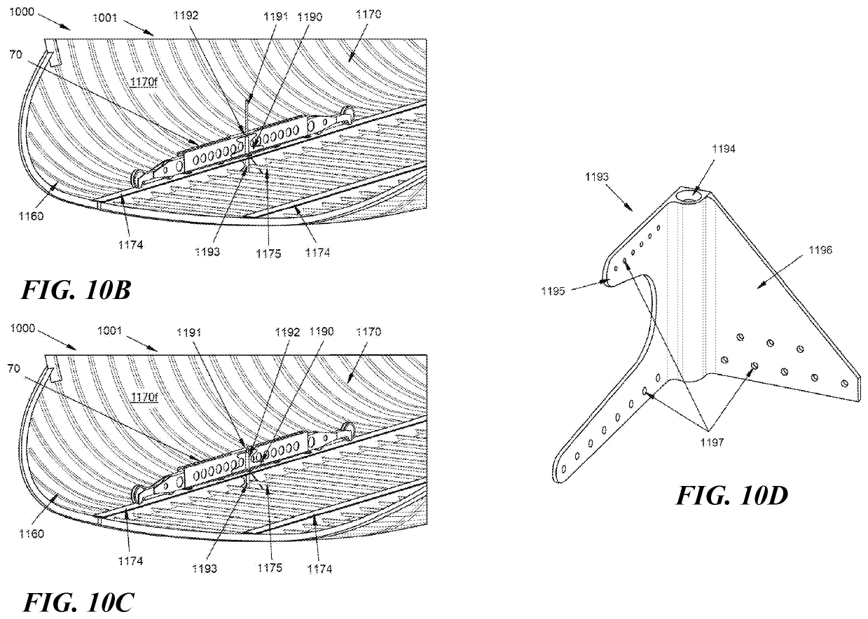

FIGS. 10A-10D illustrates one of the carriages 60, 70. In the illustrative embodiment, the carriages 60, 70 are arranged to be inserted into the aircraft 100 via the rails 1174 and subsequently secured in place on the rails 1174. In some embodiments, at least one of the first and second carriages 60, 70 can be configured to have and/or receive a ballast. The carriage 60, 70 includes a plurality of wheel sets 64, 74, with wheels 61, 71 of the wheel sets 64, 74 being coupled together by a whiffle tree 65, 75 in a linear configuration. The wheel sets 64, 74 and whiffle trees 65, 75 aid in both moving the fixture 12, and thus a payload 90 received by the fixture 12, and can also help spread the weight of the payload 90 more evenly to the rails 1174. As shown, two whiffle trees 65, 75, and thus two-wheel sets 64, 74, can be coupled together by a rectangular brace 62, 72. The rectangular brace 62, 72 can itself act as a whiffle tree, and thus provide a similar load distribution function.

A plurality of holes or openings 67, 77 are provided in the various surfaces of the brace 62, 72 as illustrated, as are a plurality of holes or openings 66, 76 in the whiffle trees 65, 75. The holes 66, 67, 76, 77 may improve aspects of the fixture 12 including, but not limited to, reducing the weight of the fixture 12 and/or providing possible locations where the fixture 12 can be secured within a cargo bay of an aircraft, such as by tying a rope or chain or the like through one or more of the openings and tightening accordingly to secure the location of the fixture 12, and thus the cargo 90 secured by the fixture 12, within the cargo bay.

A person skilled in the art will appreciate that in other embodiments, the carriages 60, 70 can more generally be referred to as bases, with a base merely being a structure from which the supports 22, 32 respectively extend. A carriage, or a plurality of carriages, is one example of a base, but in other instances, a base can be a structure (e.g., bar, brace, etc.) that does not necessarily have wheels and is thus moved by an outside component (a component with wheels, skis, skids, etc.) or by having wheels, skis, skids, etc. disposed on the base. While the illustrated embodiment includes two bases (e.g., carriages 60, 70), in other embodiments the base can be a singular structure from which one or more supports 22, 32 extend at an oblique angle as provided herein and/or the term base can encompass two or more carriages (e.g., carriages 60, 70) or the like.

FIGS. 10B and 10C illustrate one exemplary way by which the carriage 60, 70, in particular the second carriage 70 as shown in FIGS. 10B and 10C, can be secured inside a cargo bay of an aircraft. The functionality of the second carriage 70 as described herein, including all associated components, is applicable to the carriage 60. As shown, the second carriage 70 is disposed along the rail 1174 of the cargo bay 1170 of the aircraft 1100. The second carriage 170 can translate along the rail 1174 as described herein. When it reaches a desired location, as shown here, in the forward end 1170f of the cargo bay 170 with a portion of the carriage 70 disposed on the cantilevered tongue 1160, it can be secured by way of a mounting plate 1190 coupled to the carriage 70 and a locking pin 1191. More particularly, as shown, the mounting plate 1190 can be disposed on one of two opposed main surfaces of the rectangular brace 72.

The mounting plate 1190 includes a bore 192 extending vertically therethrough. The bore 1192 can be aligned with a bore 1194 (FIG. 10D) of a hardpoint fitting 1193 coupled to the rail 1174 or otherwise disposed in the cargo bay. The locking pin 1191 can be driven into both bores 1192, 1194 to secure the location of the carriage 70 with respect to the rail 1174. When further transportation of the carriage 70 is desired, such as when unloading the cargo 90 from the aircraft 100, the locking pin 1191 can be removed from the hardpoint fitting 193 and/or the carriage 70, thereby permitting movement of the carriage 70 with respect to the rail 1174. Notably, although the carriage 70 is described in this context one of two carriages 60, 70, in other embodiments it can be a standalone carriage that is configured, perhaps in conjunction with other carriages disposed linearly along a length of a payload to be transported, to translate a payload through at least a portion of a cargo bay of the aircraft 100.

A non-limiting exemplary embodiment of the hardpoint fitting 1193 is illustrated in FIG. 10D. The bore 1194 for receiving the locking pin 1191 extends throughout a length of hardpoint fitting 1193. Plates 1195, 1196 extend substantially perpendicular to each other from the portion of the fitting 1193 that forms the bore 1194, allowing the hardpoint fitting 1193 to be mounted to substantially perpendicular structures within the interior cargo bay 1170—as shown in FIGS. 10B and 10C, the rail 1174 and a transverse frame 1175. The plates 1195, 1196 can have a variety of configurations, and can be adapted for the surface(s) to which they will be connected. For example, the plate 1195, which includes a more curved profile, is configured to attach to the face of the rail 1174, with two lines of bolts (via bores 1194) being used to react to a load and a moment about the vehicle pitch axis, while the plate 1196, which has a more triangular shaped profile, is configured to attach to a fuselage transverse frame, which may be less tall than the rail 1174 and only react a force transverse to the vehicle longitudinal axis. Various bores 1197 (not all labeled) can be formed therein to assist in mounting the hardpoint fitting 1193 within the cargo bay 1170. Any number of hardpoint fittings 1193 (or other configurations of hardpoint fittings) can be provided throughout the entirety of the interior cargo bay 1170, and they can be placed in desirable locations for securing cargo within the bay 1170.

Different hardpoint fittings can be designated for use with different types and sizes of cargos. The illustrated hardpoint fitting 1193 is but one example. In some embodiments, there can be approximately in the range of about 20 hardpoint fittings to about 40 hardpoint fittings within the interior cargo bay 1170, although more or less are possible as well. In alternative embodiments, some portion of the payload can be directly coupled to the hardpoint fittings 1193, rather than via payload-receiving fixtures. A person skilled in the art, in view of the present disclosures, will understand other ways by which a payload can be secured within the interior cargo bay 1170, including by various attachment mechanisms known to those skilled in the art that can be used or otherwise adapted for use with the rail 1174 and/or one or more attachment mechanisms known to those skilled in the art that can be placed in the interior cargo bay and used to secure the location of the payload with respect to the rail 1174 and/or the interior cargo bay 1170 more generally.

As described above, the nose cone 1126 may also function as a door, optionally referred to as the nose cone door 1126, thus allowing access to an interior cargo bay 1170 defined by the fuselage 1001 via a cargo opening 1171 exposed by moving the nose cone door 1126 into an open or loading position. FIG. 11 shows the cantilevered payload-receiving fixture 12 in the context of the aircraft 1000 with an opened nose cone 1126. This shows that the payload-receiving fixture 12 can react to loads from the end of the turbine blades 90, 98 aft (+x) and/or down (−z) to the rails 1174, and further shows arrows 87, 88, 89 that depict how the geometry of the payload-receiving fixture 12 can be modified to allow the turbine blades 90, 98 to more fully occupy otherwise unusable nose cone door cargo volume 1170n. The interior cargo bay 1170 can include the nose cone door cargo volume 1170n defined by nose cone door 1126 when closed. As can be seen, the base of the payload-receiving fixture 12, in particular the forward ends or wheels 61, 71 of the carriages 60, 70 and the brackets 25, 35, can remain aft of the aircraft nose door opening. The terminal ends 24, 34 of the cantilevered supports 20, 30 can thus extend at least partially into the nose cone door cargo volume 1170n, an area that is typically unused, or at best barely used (less than approximately 5% of volume used), in aircraft cargo transport scenarios. As such, longer turbine blades 90, 98 may be transported within the aircraft 1000 than conventionally possible. The cantilevered payload-receiving fixture 12, as well as fixtures 210 and 310 described below and other cantilevered payload-receiving fixtures derivable from the present disclosures, can enable a substantially greater portion of the volume of the nose cone door cargo volume 1170n to be used, including at least about 10% of the volume, at least about 15% of the volume, at least about 20% of the volume, at least about 25% of the volume, at least about 30% of the volume, at least about 35% of the volume, at least about 40% of the volume, at least about 45% of the volume, and at least about 50% of the volume, if not more (e.g., upwards of about 55% of the volume to about 80% of the volume). These same percentages can be applicable to an amount of tailcone volume that can be used as a result of implementing cantilevered payload-receiving fixtures as described herein. Moreover, the base of the cantilevered payload-receiving fixture 12 can be such that it does not impart any moments to the aircraft 100 structure that act through the skin surface.

Another embodiment of a payload-receiving fixture 210 in accordance with the present disclosure is shown in FIGS. 12 and 13. The payload-receiving fixture 210 can be substantially similar to the payload-receiving fixture 12 described herein. Accordingly, similar reference numbers in the 200 series indicate features that are common between the payload-receiving fixture 210 and the payload-receiving fixture 12. The descriptions of the payload-receiving fixture 12 are incorporated by reference to apply to the payload-receiving fixture 210, except in instances when it conflicts with the specific description and the drawings of the payload-receiving fixture 210. Any combination of the components of the payload-receiving fixture 12 and the payload-receiving fixture 210 described in further detail below may be utilized in an assembly of the present disclosure.

Similar to the payload-receiving fixture 12, the payload-receiving fixture 210 can include a first cantilevered support 220, a second cantilevered support 230, a support beam 240 extending between and interconnecting the first and second cantilevered supports 220, 230 and two carriages 260, 270 from which the cantilevered supports 220, 230 extend. The support beam 240 may include a saddle 240 as described above, as well as interface 244, 245, 246 for coupling and supporting the root 94 of the blade 90. The cantilevered supports 220, 230 differ from the first and second cantilevered supports 20, 30 in several aspects. First, the support bodies 222, 232 are not formed as solid, generally planar sheets of material, but instead include upper and lower support rods as well as trusses. For example, the first support body 222, as shown in FIG. 12, can include upper and lower caps 222U, 222L with a plurality of trusses 222T extending therebetween to form substantially triangular support sections of trusses 222T. The use of trusses 222T instead of planar sheets of material can reduce weight of the cantilevered supports 220, 230 without necessarily sacrificing strength and support. Such truss configurations can be applied to the cantilevered payload-receiving fixture 12.

Moreover, the cantilevered supports 220, 230 further include longer, straight-edged second terminal ends 224, 234 (edges 224e and 234e) than the terminal ends 24, 34, as shown in FIG. 12. The terminal ends 224, 234 extending over a greater vertical length can allow for the interfaces 245, 246 to extend higher up along the sides of the root 94 of the wind turbine blade 90. The terminal ends 224, 234 may be formed as support rods that extend between the upper and lower caps 222U, 222L, 232U, 232L. This can allow for a greater portion of the circumference of the root 94 of the blade 90 to be supported by the interfaces 245, 246. A distance d′, measured from an approximate center C′ of the payload-receiving fixture 212 to the terminal end 224e can have similar values as described above for the distance d illustrated in FIGS. 8 and 9.

Additionally, the illustrated cantilevered supports 220, 230 can extend further into the nose cone door cargo volume 1170n of the aircraft 1000 than the cantilevered supports 20, 30 of the payload-receiving fixture 12. Specifically, the cantilevered supports 220, 230 can extend away from the carriages 260, 270 at an angle 229, 239 relative to longitudinal axes of the carriages 260, 270 and the bottom edges of the supports 220, 230 that is smaller than the first and second angles 29, 39 described above. The angles are approximately in the range of about 10 degrees to about 70 degrees, and more particularly approximately in the range of about 15 degrees to about 60 degrees, and more particularly approximately in the range of about 20 degrees to about 50 degrees, and more particularly approximately in the range of about 25 degrees to about 40 degrees. In the illustrative embodiment, the angles 229, 239 are approximately 20 degrees. The term “approximately” as used in the context of angular measurements refers to +/−3 degrees of the indicated value. The angles 229, 239 being smaller allows for the terminal ends 224, 234 of the supports 220, 230 to extend further into the nose cone door cargo volume 1170n. In particular, the distance 279 from the forward edge 1174f of the rail 1174 to the terminal ends 224, 234 may be optimized by varying the angles 229, 239. For example, similar to the distance 79, the distance 279 can be approximately in the range of about 0 meters to about 6 meters, and in some embodiments it can be about 4 meters. Similar to the distances d and 79 escribed above, the ranges and values associated with the distance 279 are for illustrative purposes and the present disclosure is not necessarily bound by the ranges and values. These same designs can be carried out on smaller scales (e.g., millimeters rather than meters, or less) and significantly larger scales (e.g., 10 times the values described herein, or greater).

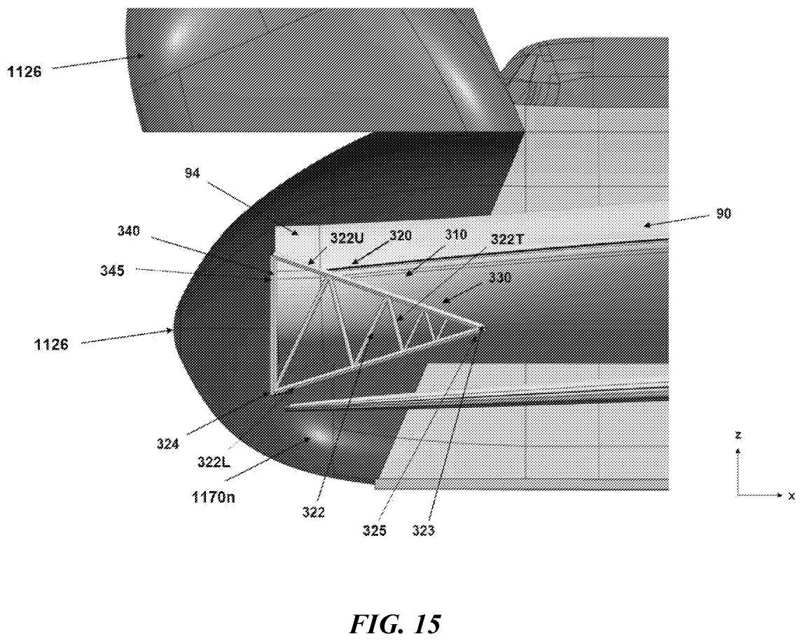

Another embodiment of a cantilevered payload-receiving fixture 310 in accordance with the present disclosure is shown in FIGS. 14-16. The cantilevered payload-receiving fixture 310 can be substantially similar to the payload-receiving fixtures 12, 210 in its purpose and in some designs, although a primary difference is the fixture 310 connects directly to the aircraft itself (although it is noted that the present application contemplates that the fixtures 12, 210 can also be connected directly to the aircraft if desired). Accordingly, similar reference numbers in the 310 series indicate features that can be common between the payload-receiving fixture 310 and the payload-receiving fixtures 12, 210, unless indicated otherwise or unless understood such similarities would not be possible in view of the different embodiments. The descriptions of the payload-receiving fixtures 12, 210 are incorporated by reference to apply to the payload-receiving fixture 310, except in instances when it conflicts with the specific description and the drawings of the fixture 310. Any combination of the components of the payload-receiving fixtures 12, 210 and the payload-receiving fixture 310 described in further detail below may be utilized in an assembly of the present disclosure.

Similar to the payload-receiving fixtures 12, 210, the payload-receiving fixture 310 can include a first cantilevered support 320, a second cantilevered support 330, and a support beam 340 that can extend between and interconnect the first and second cantilevered supports 320, 330. The support beam 340 may include the saddle 344 (not shown due to viewing angle) described above, as well as an interfaces 344 (not shown due to viewing angle), 345, and 346 (not shown due to viewing angle), for coupling and supporting the root 94 of the blade 90. An additional support rod 340U may be included that can extend between top ends of the terminal ends 324, 334. The cantilevered supports 320, 330 may differ from the cantilevered supports 20, 30 and the cantilevered supports 220, 230 in several aspects. Firstly, similarly to the support bodies 222, 232, the support bodies 322, 332 can include upper and lower support rods as well as trusses. For example, the first support body 322, as shown in FIG. 14, can include upper and lower support rods 322U, 322L with a plurality of trusses 322T extending therebetween to form substantially triangular support sections of trusses 322T. The use of trusses 322T instead of planar sheets of material can reduce the weight of the cantilevered supports 320, 330. Moreover, similar to the cantilevered supports 220, 230, the cantilevered supports 320, 330 can include longer, straight-edged second terminal ends 324, 334 than the terminal ends 24, 34, as shown in FIG. 14. The second terminal ends 324, 334 can be formed as support rods and extend over a greater vertical length, thus allowing for the interfaces 345, 346 to extend higher up along the sides of the root 94 of the wind turbine blade 90. This can allow for a greater portion of the circumference of the root 94 of the blade 90 to be supported by the interfaces 345, 346. In the illustrated embodiment, the side interfaces 345, 346 extend approximately halfway up the terminal ends 324, 334.

Moreover, the payload-receiving fixture 310 can differ from the fixtures 12, 210 in that, instead of utilized carriages on the rails 1174 described above, the first terminal ends 323, 333 of the support bodies 322, 332 can be coupled to side surfaces 1176 of the interior of the aircraft fuselage 1001 at the attachment points 325, 335 via any known fastener assembly. The side surfaces 1176 are opposed to one another, in particular on opposing sides of the fuselage 1001. Some non-limiting examples of ways by which the payload-receiving fixture 310 can be mounted to side surfaces 1176 of the aircraft 100, i.e., fastener assemblies, include a clevis joint with pin axis parallel to the aircraft y-axis, or a rigid fastener pattern. Other fastener assemblies that may be part of the fixture 310, and/or otherwise used with the fixture 10, include bolts, nuts, brackets, and the like. In this way, instead of the loads received by the payload-receiving fixture 12, 210 being transferred at least in part to the carriages 60, 70, 260, 270, the loads can be as least partially transferred to the side surfaces 1176 of the interior of the aircraft fuselage 1001. This can reduce or eliminate a need to provide rails 1174 and carriages within the aircraft cargo volume 1170. In some instances, the load terminates in a simply-supported boundary condition that does not react to moments. A person skilled in the art would understand that the attachment points 325, 335 on the side surfaces 1176 may be aligned such that each is substantially co-planar with a plane that extends parallel to floor plane (e.g., the floor plane 81f), and thus each can be disposed approximately the same distance from the bottom surface (e.g., the floor 172) of the aircraft 100. Alternatively, the attachment points 325, 335 can be staggered on the opposed side surfaces 1176. The location of the attachment points 325, 335 can be based, at least in part, on the design requirements of the aircraft 1000 and/or fixture 310, as well as the size, shape, and/or weight of the payload with which the fixture 310 is being used.

The attachment points 325, 335 can be fixed or removable as desired. In some embodiments, the attachment points 325, 335 can allow for rotational movement of the support bodies 322, 332 and other components associated therewith such that the payload-receiving fixture 310 can be selectively positioned in the nose cone door cargo volume 1170n and moved out of it. A person skilled in the art will appreciate such a configuration may require the disassembly of one or more components of the fixture 310, such as the support beam 340 connecting the two support bodies 322, 332, to allow for the fixture 310 to be moved between a first configuration in which it is not disposed in the nose cone door cargo volume 1170n and a second configuration in which it is disposed in the nose cone door cargo volume 1170n so that it can support a payload therein.

The upper and lower support rods 322U, 332U, 322L, 332L of each cantilevered support 320, 330 can extend away from the side surfaces 176 of the interior of the aircraft fuselage 101, as measured along lines 176a, respectively, at an angle 329, 339 that is approximately in the range of about 10 degrees to about 45 degrees, and more particularly is approximately in the range of about 20 degrees to about 35 degrees. In the illustrative embodiment, the angle is approximately 28 degrees. Additionally, the cantilevered supports 320, 330 can extend further into the nose cone door cargo volume 170n of the aircraft 100 than the cantilevered supports 20, 30 of the payload-receiving fixture 12. In particular, the cantilevered supports 320, 330 can extend into the nose cone area of the aircraft 100, approximately the same distance as the cantilevered supports 220, 230, or even more.

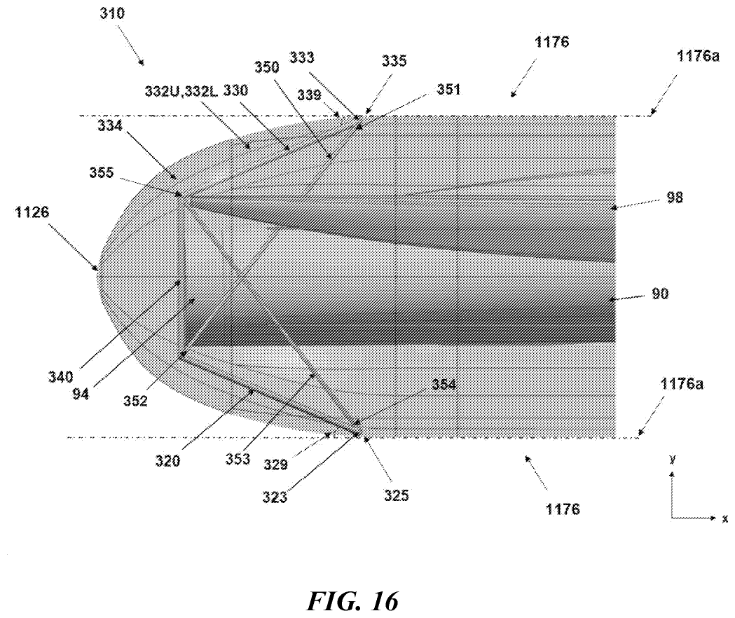

In the illustrated embodiment, the fixture 310 can further include a first support rod 350 and a second support rod 353, as shown in FIG. 16. The first support rod 350 can include a first terminal end 351 coupled to the first terminal end 333 of the second cantilevered support 330 and can extend to a second terminal end 352 opposite the first terminal end 351. The second terminal end 352 can be coupled to a lower portion of the second terminal end 324 of the first cantilevered support 320. Similarly, the second support rod 353 can include a first terminal end 354 coupled to the first terminal end 323 of the first cantilevered support 320 and can extend to a second terminal end 355 opposite the first terminal end 354, the second terminal end 355 being coupled to a lower portion of the second terminal end 334 of the second cantilevered support 330. The support rods 350, 353 can extend to the lower portions of the terminal ends 324, 334 such that the support rods 350, 353 can be located beneath the blade 90 when the blade 90 is mounted on the fixture 310. In the illustrated embodiment, the support rods 350, 353 can intersect at an intersection point 356. The support rods 350, 353 may be adhered to each other at the intersection point 356 to provide additional structural rigidity.

Notably, in each of the illustrated embodiments, the cantilevered payload-receiving fixtures 12, 210, 310 allows for payload to be supported within the nose cone door cargo volume 170n without having any portion of the fixture in contact with, or otherwise engaged with, a bottom surface of the nose cone or nose cone door 126. The design of the cantilevered payload-receiving fixtures 12, 210, 310 is such that the supports of the fixtures (e.g., supports 22, 32, 222, 232, 322, 332) can extend into the nose cone door cargo volume 170n, and support loads from a payload in the same, without having to account for putting a structure on the floor or bottom surface of the nose cone or nose cone door to support the payload. This provides added flexibility to be able to load large payloads into the aircraft, affording for more use of the nose cone door cargo volume 170n, and the volume of the interior cargo bay as a whole, than was previously possible.

One skilled in the art will appreciate further features and advantages of the disclosure based on the above-described embodiments. Accordingly, the disclosure is not to be limited by what has been particularly shown and described, except as indicated by the appended claims. By way of non-limiting example, although the present disclosure describes using the illustrated payload-receiving fixture in conjunction with a forward end of a payload to extend the payload into a nose cone volume, the disclosed payload-receiving fixtures can be used in conjunction with an aft end of a payload to extend the payload further aft into the interior cargo bay, including into a tailcone, than may otherwise be possible. All publications and references cited herein are expressly incorporated herein by reference in their entirety.

Examples of the above-described embodiments can include the following:
1. A fixture for supporting a payload, comprising:
   a first base having a first longitudinal axis extending a length thereof;
   a second base having a second longitudinal axis extending a length thereof, the first and second longitudinal axes being substantially parallel to each other;
   a first cantilevered support coupled to the first base and extending at an oblique angle with respect to the first longitudinal axis;
   a second cantilevered support coupled to the second base and extending at an oblique angle with respect to the second longitudinal axis, the first and second cantilevered supports extending substantially parallel to each other; and
   a support beam extending between the first and second cantilevered supports such that a first end of the support beam is coupled to the first cantilevered support and a second end of the support beam is coupled to the second cantilevered support, the support beam being configured to receive a payload, the first end of the support beam being a first longitudinal distance away from a first vertical axis extending substantially perpendicular to the first longitudinal axis when measured along a line that is substantially parallel to the first longitudinal axis and extends between the first vertical axis and the first end of the support beam, and the second end of the support beam being a second longitudinal distance away from a second vertical axis extending substantially perpendicular to the second longitudinal axis when measured along a line that is substantially parallel to the second longitudinal axis and extends between the second vertical axis and the second end of the support beam.
2. The fixture of claim 1, wherein the first and second bases comprise first and second carriages, respectively, each of the first and second carriages comprising a brace and a plurality of wheels associated therewith.
3. The fixture of claim 2,
   wherein each of the first and second carriages further comprises one or more whiffle trees having at least some wheels of the plurality of wheels associated therewith, and
   wherein the one or more whiffle trees are configured to substantially uniformly distribute vertical forces from a payload to the at least some wheels forming the one or more whiffle trees.
4. The fixture of any of claims 1 to 3, wherein at least one of the first and second bases is configured to have a ballast.
5. The fixture of any of claims 1 to 4, further comprising:
   a saddle associated with the support beam, the saddle being configured to engage with a wind turbine blade to support the wind turbine blade.
6. The fixture of claim 5, wherein the saddle is configured to engage with a root of the wind turbine blade.
7. The fixture of any of claims 1 to 6, further comprising:
   at least one interface associated with each of the first and second cantilevered supports, the at least one interface being configured to engage with a wind turbine blade to support the wind turbine blade.
8. The fixture of claim 7, wherein the at least one interface comprises a plurality of bolt interfaces configured to engage with a root of the wind turbine blade by passing bolts therethrough and into the root of the wind turbine blade.
9. The fixture of any of claims 1 to 8, further comprising:
   a plurality of support rods extending between the two cantilevered supports, the plurality of support rods including:
      a first support rod extending from the first base to at least one of a location on the support beam proximate to the second cantilevered support or a location on the second cantilevered support proximate to the support beam; and
      a second support rod extending from the second base to at least one of a location on the support beam proximate to the first cantilevered support or a location on the first cantilevered support proximate to the support beam.
10. The fixture of any of claims 1 to 9, further comprising:
   at least one loading stand extending between the first cantilevered support and the first base.
11. The fixture of claim 10, further comprising:
   at least one loading stand extending between the second cantilevered support and the second base.
12. The fixture of any of claims 1 to 11, wherein the oblique angle formed by the first and second longitudinal axes and the respective first and second cantilevered supports is approximately in the range of about 10 degrees to about 80 degrees.
13. The fixture of any of claims 1 to 12, wherein the first and second longitudinal distances are approximately in the range of about 0.10 meters to about 10 meters.
14. The fixture of any of claims 1 to 13,
   wherein the first cantilevered support includes a first terminal end coupled to the first base, a second terminal end coupled to the support beam, and a first support body extending between the first and second terminals ends,
   wherein the second cantilevered support includes a third terminal end coupled to the second base, a fourth terminal end coupled to the support beam, and a second support body extending between the third and fourth terminals ends.
15. The fixture of any of claims 1 to 14,
   wherein the first cantilevered support comprises:
      a first upper cap;
      a first lower cap; and
      a first terminal end support rod that extends between outer terminal ends of the first upper and first lower caps,
      wherein the first upper and first lower caps extend from the first terminal end support rod to a common point on the first base such that the first upper cap, the first lower cap, and the first terminal end support rod form a substantially triangular shape, and
   wherein the second cantilevered support comprises:
      a second upper cap;
      a second lower cap; and
      a second terminal end support rod that extends between outer terminal ends of the second upper and second lower caps,
      wherein the second upper and second lower caps extend from the second terminal end support rod to a common point on the second base such that the second upper cap, the second lower cap, and the second terminal end support rod form a substantially triangular shape.
16. The fixture of claim 15,
   wherein the first cantilevered support further comprises truss support rods extending alternately between the first upper cap and the first lower cap, and
   wherein the second cantilevered support further comprises truss support rods extending alternately between the second upper cap and the second lower cap.
17. The fixture of any of claims 1 to 16, wherein the first and second cantilevered supports are configured such that the payload received by the support beam extends into a volume of a nose cone of an aircraft without any structure of the fixture, including the first base, the second base, the first cantilevered support, the second cantilevered support, and the support beam, being in contact with a bottom surface of the nose cone.
18. A system for loading a cargo aircraft, comprising:
   the fixture of any of claims 1 to 17; and
   at least one rail disposed in an interior cargo bay of a cargo aircraft, the interior cargo bay having a forward bay portion located in a forward end of the cargo aircraft and an aft bay portion located in an aft end of the cargo aircraft, the forward bay portion extending forward beyond a forward terminal end of the at least one rail,
   wherein the fixture is configured to support a payload in the forward bay portion that extends beyond the forward terminal end of the at least one rail.
19. The system of claim 18,
   wherein the interior cargo bay comprises a kinked bay portion disposed between the forward bay portion and the aft bay portion, the kinked bay portion defining a location at which the aft end of the cargo aircraft begins to raise relative to a longitudinal-lateral plane of the cargo aircraft such that an aft-most terminal end of the aft bay portion is disposed above the a forward-most terminal end of the forward bay portion,
   wherein the at least one rail extends from the forward bay portion, through the kinked bay portion, and into the aft bay portion.
20. A cargo aircraft, comprising:
   the system of claim 18 or 19; and
   an articulating nose cargo door containing a forward end of the forward bay portion and configured to move between an open position and a closed position such that, in the closed position, the articulating nose cargo door forms a closed forward end of the interior cargo bay and in the open position the articulating nose cargo door is moved to expose a cargo opening into the interior cargo bay,
   wherein the fixture is configured to support a payload in the forward bay portion that extends within a volume defined by the nose cargo door when the door is in the closed position.
21. A fixture for supporting a payload in a cargo aircraft, comprising:
   a first cantilevered support extending at a first oblique angle with respect to at least one of a base of the fixture or a floor of the cargo aircraft such that a first longitudinal axis extending through an entirety of the first cantilevered support forms the first oblique angle with at least one of a base plane extending through a substantial portion of a top surface of a base of the fixture or a floor plane extending through a substantial portion of a top surface of a floor of the cargo aircraft;
   a second cantilevered support extending at a second oblique angle with respect to at least one of the base of the fixture or the floor of the cargo aircraft such that a second longitudinal axis extending through an entirety of the second cantilevered support forms the second oblique angle with at least one of the base plane or the floor plane;
   a support beam extending between the first and second cantilevered supports such that a first end of the support beam is coupled to the first cantilevered support and a second end of the support beam is coupled to the second cantilevered support, the support beam being configured to receive a payload, the first end of the support beam being a first longitudinal distance away from a first vertical axis extending substantially perpendicular to the respective base or floor plane when measured along a line that is substantially parallel to the respective base or floor plane and extends between the first vertical axis and the first end of the support beam, and the second end of the support beam being a second longitudinal distance away from a second vertical axis extending substantially perpendicular to the respective base or floor plane when measured along a line that is substantially parallel to the respective base or floor plane and extends between the second vertical axis and the second end of the support beam.
22. The fixture of claim 21, further comprising:
   a base,
   wherein each of the first and second cantilevered supports are coupled to the base, the first cantilevered support extending at the first oblique angle with respect to the base and the second cantilevered support extending at the second oblique angle with respect to the base.
23. The fixture of claim 22, wherein the base further comprises:
   a first base having a first longitudinal axis extending a length thereof; and
   a second base having a second longitudinal axis extending a length thereof, the first and second longitudinal axes being substantially parallel to each other.
24. The fixture of claim 23, wherein the first and second bases comprise first and second carriages, respectively, each of the first and second carriages comprising a brace and a plurality of wheels associated therewith.
25. The fixture of claim 24, wherein each of the first and second carriages further comprises one or more whiffle trees having at least some wheels of the plurality of wheels associated therewith, and wherein the one or more whiffle trees are configured to substantially uniformly distribute vertical forces from a payload to the at least some wheels forming the one or more whiffle trees.
26. The fixture of any of claims 22 to 25, wherein the base is configured to have a ballast.
27. The fixture of any of claims 22 to 26, further comprising:
   a plurality of support rods extending between the two cantilevered supports, the plurality of support rods including:
      a first support rod extending from the base to at least one of a location on the support beam proximate to the second cantilevered support or a location on the second cantilevered support proximate to the support beam; and
      a second support rod extending from the base to at least one of a location on the support beam proximate to the first cantilevered support or a location on the first cantilevered support proximate to the support beam.
28. The fixture of any of claims 22 to 27, further comprising:
   at least one loading stand extending between the first cantilevered support and the base.
29. The fixture of claim 28, further comprising:
   at least one loading stand extending between the second cantilevered support and the base.
30. The fixture of any of claims 22 to 29,
   wherein the first cantilevered support includes a first terminal end coupled to the base, a second terminal end coupled to the support beam, and a first support body extending between the first and second terminals ends,
   wherein the second cantilevered support includes a third terminal end coupled to the base, a fourth terminal end coupled to the support beam, and a second support body extending between the third and fourth terminals ends.
31. The fixture of claim 21,
   wherein the first cantilevered support includes a first terminal end configured to be coupled to a first location on a first side surface of a cargo aircraft fuselage, a second terminal end coupled to the support beam, and a first support body extending between the first and second terminal ends,
   wherein the second cantilevered support includes a third terminal end configured to be coupled to a second location on a second side surface of the cargo aircraft fuselage, a fourth terminal end coupled to the support beam, and a second support body extending between the third and fourth terminal ends, and
   wherein the first and second locations on the respective first and second side surfaces of the cargo aircraft fuselage are substantially opposed to each other.
32. The fixture of claim 31, further comprising:
   a first support rod extending between the first terminal end of the first cantilevered support and one of a location on the support beam proximate to the second cantilevered support or a location on the second cantilevered support proximate to the support beam; and
   a second support rod extending between the third terminal end of the second cantilevered support and one of a location on the support beam proximate to the first cantilevered support or a location on the first cantilevered support proximate to the support beam.
33. The fixture of any of claims 21 to 32, further comprising:
   a saddle associated with the support beam, the saddle being configured to engage with a wind turbine blade to support the wind turbine blade.
34. The fixture of claim 33, wherein the saddle is configured to engage with a root of the wind turbine blade.
35. The fixture of any of claims 21 to 34, further comprising:
   at least one interface associated with each of the first and second cantilevered supports, the at least one interface being configured to engage with a wind turbine blade to support the wind turbine blade.
36. The fixture of claim 35, wherein the at least one interface comprises a plurality of bolt interfaces configured to engage with a root of the wind turbine blade by passing bolts therethrough and into the root of the wind turbine blade.
37. The fixture of any of claims 21 to 36, wherein each of the first oblique angle and the second oblique angle is approximately in the range of about 10 degrees to about 80 degrees.
38. The fixture of any of claims 21 to 37, wherein the first and second longitudinal distances are approximately in the range of about 0.10 meters to about 10 meters.
39. The fixture of any of claims 21 to 38,
   wherein the first cantilevered support comprises:
      a first upper cap;
      a first lower cap; and
      a first terminal end support rod that extends between outer terminal ends of the first upper and first lower caps,
      wherein the first upper and first lower caps extend from the first terminal end support rod to a common point on the respective base or floor such that the first upper cap, the first lower cap, and the first terminal end support rod form a substantially triangular shape, and
   wherein the second cantilevered support comprises:
      a second upper cap;
      a second lower cap; and
      a second terminal end support rod that extends between outer terminal ends of the second upper and second lower caps,
      wherein the second upper and second lower caps extend from the second terminal end support rod to a common point on the respective base or floor such that the second upper cap, the second lower cap, and the second terminal end support rod form a substantially triangular shape.
40. The fixture of claim 39,
   wherein the first cantilevered support further comprises truss support rods extending alternately between the first upper cap and the first lower cap, and
   wherein the second cantilevered support further comprises truss support rods extending alternately between the second upper cap and the second lower cap.
41. The fixture of any of claims 21 to 40, wherein the first and second cantilevered supports are configured such that the payload received by the support beam extends into a volume of a nose cone of an aircraft without any structure of the fixture, including the first base, the second base, the first cantilevered support, the second cantilevered support, and the support beam, being in contact with a bottom surface of the nose cone.
42. A system for loading a cargo aircraft, comprising:
   the fixture of any of claims 21 to 30; and
   at least one rail disposed in an interior cargo bay of a cargo aircraft, the interior cargo bay having a forward bay portion located in a forward end of the cargo aircraft and an aft bay portion located in an aft end of the cargo aircraft, the forward bay portion extending forward beyond a forward terminal end of the at least one rail,
   wherein the fixture is configured to support a payload in the forward bay portion that extends beyond the forward terminal end of the at least one rail.
43. The system of claim 42,
   wherein the interior cargo bay comprises a kinked bay portion disposed between the forward bay portion and the aft bay portion, the kinked bay portion defining a location at which the aft end of the cargo aircraft begins to raise relative to a longitudinal-lateral plane of the cargo aircraft such that an aft-most terminal end of the aft bay portion is disposed above the a forward-most terminal end of the forward bay portion,
   wherein the at least one rail extends from the forward bay portion, through the kinked bay portion, and into the aft bay portion.
44. A cargo aircraft, comprising:
   the system of claim 42 or 43; and
   an articulating nose cargo door containing a forward end of the forward bay portion and configured to move between an open position and a closed position such that, in the closed position, the articulating nose cargo door forms a closed forward end of the interior cargo bay and in the open position the articulating nose cargo door is moved to expose a cargo opening into the interior cargo bay,
   wherein the fixture is configured to support a payload in the forward bay portion that extends within a volume defined by the nose cargo door when the door is in the closed position.
45. A cargo aircraft, comprising:
   a fuselage having a first side surface and a second side surface that is substantially opposed to the first side surface; and
   the fixture of claim 31 or 32, with the first terminal end of the first cantilevered support being coupled to a first location on the first side surface and the third terminal end of the second cantilevered support being coupled to a second location on the second side surface.
46. The cargo aircraft of claim 45, further comprising:
   an articulating nose cargo door containing a forward end of the forward bay portion and configured to move between an open position and a closed position such that, in the closed position, the articulating nose cargo door forms a closed forward end of the interior cargo bay and in the open position the articulating nose cargo door is moved to expose a cargo opening into the interior cargo bay,
   wherein the fixture is configured to support a payload in the forward bay portion that extends within a volume defined by the nose cargo door when the door is in the closed position.
47. A method of supporting a payload within an aircraft, comprising:
   disposing a cantilevered payload-receiving fixture having a plurality of cantilevered supports in an interior cargo bay of an aircraft such that both a receiving portion of the cantilevered payload-receiving fixture located at terminal ends of the plurality of cantilevered supports and a payload supported by the receiving portion are disposed within a nose cone door cargo volume of the aircraft while opposed terminal ends of the plurality of cantilevered supports are disposed in the interior cargo bay, outside of the nose cone door cargo volume of the aircraft.
48. The method of claim 47, wherein disposing the cantilevered payload-receiving fixture having a plurality of cantilevered supports in an interior cargo bay of an aircraft further comprises:
   coupling the cantilevered payload-receiving fixture to at least one rail disposed within the interior cargo bay of the aircraft; and
   advancing the cantilevered payload-receiving fixture along the at least one rail.
49. The method of claim 47 or 48, wherein disposing the cantilevered payload-receiving fixture having a plurality of cantilevered supports in an interior cargo bay of an aircraft further comprises:
   rolling the cantilevered payload-receiving fixture into the interior cargo bay.
50. The method of claim 49, wherein rolling the payload-receiving fixture further comprises:
   positioning at least a portion of the cantilevered payload-receiving fixture on a cantilevered tongue of a fuselage of the aircraft.
51. The method of claim 47, wherein disposing the cantilevered payload-receiving fixture having a plurality of cantilevered supports in an interior cargo bay of an aircraft further comprises:
   coupling the payload to the cantilevered payload-receiving fixture,
   wherein the cantilevered payload-receiving fixture is coupled to side surfaces of a fuselage of the aircraft.
52. The method of any of claims 47 to 51, further comprising:
   moving an articulating nose cargo door of the aircraft from a closed position to an open position to expose a cargo opening into the interior cargo bay,
   wherein, in the closed position, the articulating nose cargo door forms a closed forward end of the interior cargo bay
53. The method of any of claims 47 to 52, wherein the plurality of cantilevered supports extend at an oblique angle with respect to a floor of the aircraft.
54. The method of claim 53, wherein the oblique angle is approximately in the range of about 10 degrees to about 80 degrees.
55. The method of any of claims 47 to 54, further comprising:
   applying a ballast to the cantilevered payload-receiving fixture.
56. The method of any of claims 47 to 55, wherein no structure of the cantilevered payload-receiving fixture, including the plurality of cantilevered supports or one or more bases of the cantilevered payload-receiving fixture if such one or more bases are provided, is in contact with a bottom surface of the nose cone of the aircraft.
57. The method of any of claims 47 to 56, wherein the payload comprises at least one wind turbine blade.
58. The method of any of claims 47 to 57, wherein a length of the payload is at least about 57 meters.
59. The method of claim 58, wherein the length of the payload is at least 100 meters.
60. The method of claim 59, wherein the length of the payload is at least 120 meters.

1. A fixture for supporting a payload, comprising:
a first base having a first longitudinal axis extending a length thereof;
a second base having a second longitudinal axis extending a length thereof, the first and second longitudinal axes being substantially parallel to each other;
a first cantilevered support coupled to the first base and extending at an oblique angle with respect to the first longitudinal axis;
a second cantilevered support coupled to the second base and extending at an oblique angle with respect to the second longitudinal axis, the first and second cantilevered supports extending substantially parallel to each other; and
a support beam extending between the first and second cantilevered supports such that a first end of the support beam is coupled to the first cantilevered support and a second end of the support beam is coupled to the second cantilevered support, the support beam being configured to receive a payload, the first end of the support beam being a first longitudinal distance away from a first vertical axis extending substantially perpendicular to the first longitudinal axis when measured along a line that is substantially parallel to the first longitudinal axis and extends between the first vertical axis and the first end of the support beam, and the second end of the support beam being a second longitudinal distance away from a second vertical axis extending substantially perpendicular to the second longitudinal axis when measured along a line that is substantially parallel to the second longitudinal axis and extends between the second vertical axis and the second end of the support beam.

2. The fixture of claim 1, wherein the first and second bases comprise first and second carriages, respectively, each of the first and second carriages comprising a brace and a plurality of wheels associated therewith.

3-8. (canceled)

9. The fixture of claim 1, further comprising:
a plurality of support rods extending between the two cantilevered supports, the plurality of support rods including:
a first support rod extending from the first base to at least one of a location on the support beam proximate to the second cantilevered support or a location on the second cantilevered support proximate to the support beam; and
a second support rod extending from the second base to at least one of a location on the support beam proximate to the first cantilevered support or a location on the first cantilevered support proximate to the support beam.

10. (canceled)

11. (canceled)

12. The fixture of claim 1, wherein the oblique angle formed by the first and second longitudinal axes and the respective first and second cantilevered supports is approximately in the range of about 10 degrees to about 80 degrees.

13. The fixture of claim 1, wherein the first and second longitudinal distances are approximately in the range of about 0.10 meters to about 10 meters.

14. The fixture of claim 1,
wherein the first cantilevered support includes a first terminal end coupled to the first base, a second terminal end coupled to the support beam, and a first support body extending between the first and second terminals ends,
wherein the second cantilevered support includes a third terminal end coupled to the second base, a fourth terminal end coupled to the support beam, and a second support body extending between the third and fourth terminals ends.

15. The fixture of claim 1,
wherein the first cantilevered support comprises:
a first upper cap;
a first lower cap; and
a first terminal end support rod that extends between outer terminal ends of the first upper and first lower caps,
wherein the first upper and first lower caps extend from the first terminal end support rod to a common point on the first base such that the first upper cap, the first lower cap, and the first terminal end support rod form a substantially triangular shape, and
wherein the second cantilevered support comprises:
a second upper cap;
a second lower cap; and
a second terminal end support rod that extends between outer terminal ends of the second upper and second lower caps,
wherein the second upper and second lower caps extend from the second terminal end support rod to a common point on the second base such that the second upper cap, the second lower cap, and the second terminal end support rod form a substantially triangular shape.

16. The fixture of claim 15,
wherein the first cantilevered support further comprises truss support rods extending alternately between the first upper cap and the first lower cap, and
wherein the second cantilevered support further comprises truss support rods extending alternately between the second upper cap and the second lower cap.

17. The fixture of claim 1, wherein the first and second cantilevered supports are configured such that the payload received by the support beam extends into a volume of a nose cone of an aircraft without any structure of the fixture, including the first base, the second base, the first cantilevered support, the second cantilevered support, and the support beam, being in contact with a bottom surface of the nose cone.

18. A system for loading a cargo aircraft, comprising:
the fixture of claim 1; and
at least one rail disposed in an interior cargo bay of a cargo aircraft, the interior cargo bay having a forward bay portion located in a forward end of the cargo aircraft and an aft bay portion located in an aft end of the cargo aircraft, the forward bay portion extending forward beyond a forward terminal end of the at least one rail,
wherein the fixture is configured to support a payload in the forward bay portion that extends beyond the forward terminal end of the at least one rail.

19. The system of claim 18,
wherein the interior cargo bay comprises a kinked bay portion disposed between the forward bay portion and the aft bay portion, the kinked bay portion defining a location at which the aft end of the cargo aircraft begins to raise relative to a longitudinal-lateral plane of the cargo aircraft such that an aft-most terminal end of the aft bay portion is disposed above the a forward-most terminal end of the forward bay portion,
wherein the at least one rail extends from the forward bay portion, through the kinked bay portion, and into the aft bay portion.

20. A cargo aircraft, comprising:
the system of claim 18; and
an articulating nose cargo door containing a forward end of the forward bay portion and configured to move between an open position and a closed position such that, in the closed position, the articulating nose cargo door forms a closed forward end of the interior cargo bay and in the open position the articulating nose cargo door is moved to expose a cargo opening into the interior cargo bay,
wherein the fixture is configured to support a payload in the forward bay portion that extends within a volume defined by the nose cargo door when the door is in the closed position.

21. A fixture for supporting a payload in a cargo aircraft, comprising:
a first cantilevered support extending at a first oblique angle with respect to at least one of a base of the fixture or a floor of the cargo aircraft such that a first longitudinal axis extending through an entirety of the first cantilevered support forms the first oblique angle with at least one of a base plane extending through a substantial portion of a top surface of a base of the fixture or a floor plane extending through a substantial portion of a top surface of a floor of the cargo aircraft;
a second cantilevered support extending at a second oblique angle with respect to at least one of the base of the fixture or the floor of the cargo aircraft such that a second longitudinal axis extending through an entirety of the second cantilevered support forms the second oblique angle with at least one of the base plane or the floor plane;
a support beam extending between the first and second cantilevered supports such that a first end of the support beam is coupled to the first cantilevered support and a second end of the support beam is coupled to the second cantilevered support, the support beam being configured to receive a payload, the first end of the support beam being a first longitudinal distance away from a first vertical axis extending substantially perpendicular to the respective base or floor plane when measured along a line that is substantially parallel to the respective base or floor plane and extends between the first vertical axis and the first end of the support beam, and the second end of the support beam being a second longitudinal distance away from a second vertical axis extending substantially perpendicular to the respective base or floor plane when measured along a line that is substantially parallel to the respective base or floor plane and extends between the second vertical axis and the second end of the support beam.

22. The fixture of claim 21, further comprising:
a base,
wherein each of the first and second cantilevered supports are coupled to the base, the first cantilevered support extending at the first oblique angle with respect to the base and the second cantilevered support extending at the second oblique angle with respect to the base.

23. The fixture of claim 22, wherein the base further comprises:
a first base having a first longitudinal axis extending a length thereof; and
a second base having a second longitudinal axis extending a length thereof, the first and second longitudinal axes being substantially parallel to each other.

24-26. (canceled)

27. The fixture of claim 22, further comprising:
a plurality of support rods extending between the two cantilevered supports, the plurality of support rods including:
a first support rod extending from the base to at least one of a location on the support beam proximate to the second cantilevered support or a location on the second cantilevered support proximate to the support beam; and
a second support rod extending from the base to at least one of a location on the support beam proximate to the first cantilevered support or a location on the first cantilevered support proximate to the support beam.

28. (canceled)

29. (canceled)

30. The fixture of claim 22,
wherein the first cantilevered support includes a first terminal end coupled to the base, a second terminal end coupled to the support beam, and a first support body extending between the first and second terminals ends,
wherein the second cantilevered support includes a third terminal end coupled to the base, a fourth terminal end coupled to the support beam, and a second support body extending between the third and fourth terminals ends.

31. The fixture of claim 21,
wherein the first cantilevered support includes a first terminal end configured to be coupled to a first location on a first side surface of a cargo aircraft fuselage, a second terminal end coupled to the support beam, and a first support body extending between the first and second terminal ends,
wherein the second cantilevered support includes a third terminal end configured to be coupled to a second location on a second side surface of the cargo aircraft fuselage, a fourth terminal end coupled to the support beam, and a second support body extending between the third and fourth terminal ends, and
wherein the first and second locations on the respective first and second side surfaces of the cargo aircraft fuselage are substantially opposed to each other.

32. The fixture of claim 31, further comprising:
a first support rod extending between the first terminal end of the first cantilevered support and one of a location on the support beam proximate to the second cantilevered support or a location on the second cantilevered support proximate to the support beam; and
a second support rod extending between the third terminal end of the second cantilevered support and one of a location on the support beam proximate to the first cantilevered support or a location on the first cantilevered support proximate to the support beam.

33-36. (canceled)

37. The fixture of claim 21, wherein each of the first oblique angle and the second oblique angle is approximately in the range of about 10 degrees to about 80 degrees.

38. The fixture of claim 21, wherein the first and second longitudinal distances are approximately in the range of about 0.10 meters to about 10 meters.

39. The fixture of claim 21,
wherein the first cantilevered support comprises:
a first upper cap;
a first lower cap; and
a first terminal end support rod that extends between outer terminal ends of the first upper and first lower caps,
wherein the first upper and first lower caps extend from the first terminal end support rod to a common point on the respective base or floor such that the first upper cap, the first lower cap, and the first terminal end support rod form a substantially triangular shape, and
wherein the second cantilevered support comprises:
a second upper cap;
a second lower cap; and
a second terminal end support rod that extends between outer terminal ends of the second upper and second lower caps,
wherein the second upper and second lower caps extend from the second terminal end support rod to a common point on the respective base or floor such that the second upper cap, the second lower cap, and the second terminal end support rod form a substantially triangular shape.

40. The fixture of claim 39,
wherein the first cantilevered support further comprises truss support rods extending alternately between the first upper cap and the first lower cap, and
wherein the second cantilevered support further comprises truss support rods extending alternately between the second upper cap and the second lower cap.

41. The fixture of claim 21, wherein the first and second cantilevered supports are configured such that the payload received by the support beam extends into a volume of a nose cone of an aircraft without any structure of the fixture, including the first base, the second base, the first cantilevered support, the second cantilevered support, and the support beam, being in contact with a bottom surface of the nose cone.

42. A system for loading a cargo aircraft, comprising:
the fixture of claim 21; and
at least one rail disposed in an interior cargo bay of a cargo aircraft, the interior cargo bay having a forward bay portion located in a forward end of the cargo aircraft and an aft bay portion located in an aft end of the cargo aircraft, the forward bay portion extending forward beyond a forward terminal end of the at least one rail,
wherein the fixture is configured to support a payload in the forward bay portion that extends beyond the forward terminal end of the at least one rail.

43. The system of claim 42,
wherein the interior cargo bay comprises a kinked bay portion disposed between the forward bay portion and the aft bay portion, the kinked bay portion defining a location at which the aft end of the cargo aircraft begins to raise relative to a longitudinal-lateral plane of the cargo aircraft such that an aft-most terminal end of the aft bay portion is disposed above the a forward-most terminal end of the forward bay portion,
wherein the at least one rail extends from the forward bay portion, through the kinked bay portion, and into the aft bay portion.

44. A cargo aircraft, comprising:
the system of claim 42; and
an articulating nose cargo door containing a forward end of the forward bay portion and configured to move between an open position and a closed position such that, in the closed position, the articulating nose cargo door forms a closed forward end of the interior cargo bay and in the open position the articulating nose cargo door is moved to expose a cargo opening into the interior cargo bay,
wherein the fixture is configured to support a payload in the forward bay portion that extends within a volume defined by the nose cargo door when the door is in the closed position.

45. A cargo aircraft, comprising:
a fuselage having a first side surface and a second side surface that is substantially opposed to the first side surface; and
the fixture of claim 21, with the first terminal end of the first cantilevered support being coupled to a first location on the first side surface and the third terminal end of the second cantilevered support being coupled to a second location on the second side surface.

46. The cargo aircraft of claim 45, further comprising:
an articulating nose cargo door containing a forward end of the forward bay portion and configured to move between an open position and a closed position such that, in the closed position, the articulating nose cargo door forms a closed forward end of the interior cargo bay and in the open position the articulating nose cargo door is moved to expose a cargo opening into the interior cargo bay,
wherein the fixture is configured to support a payload in the forward bay portion that extends within a volume defined by the nose cargo door when the door is in the closed position.

47. A method of supporting a payload within an aircraft, comprising:
disposing a cantilevered payload-receiving fixture having a plurality of cantilevered supports in an interior cargo bay of an aircraft such that both a receiving portion of the cantilevered payload-receiving fixture located at terminal ends of the plurality of cantilevered supports and a payload supported by the receiving portion are disposed within a nose cone door cargo volume of the aircraft while opposed terminal ends of the plurality of cantilevered supports are disposed in the interior cargo bay, outside of the nose cone door cargo volume of the aircraft.

48-60. (canceled)
